(19) United States
(12) Patent Application Publication
(10) Pub. No.: US 2026/0010282 A1
(43) Pub. Date: Jan. 8, 2026

(54) ELECTRONIC DEVICE, METHOD AND RECORDING MEDIUM FOR SUPPORTING FAST SCROLL

(71) Applicant: SAMSUNG ELECTRONICS CO., LTD., Suwon-si (KR)

(72) Inventors: Nina LEE, Suwon-si (KR); Seungyong LEE, Suwon-si (KR); Yeunwook LIM, Suwon-si (KR); Jinyung JUNG, Suwon-si (KR); Junsu HWANG, Suwon-si (KR)

(73) Assignee: SAMSUNG ELECTRONICS CO., LTD., Suwon-si (KR)

(21) Appl. No.: 19/271,361

(22) Filed: Jul. 16, 2025

Related U.S. Application Data
(63) Continuation of application No. PCT/KR2025/009600, filed on Jul. 4, 2025.

(30) Foreign Application Priority Data
Jul. 8, 2024 (KR) 10-2024-0089815
Aug. 27, 2024 (KR) 10-2024-0115393

(51) Int. Cl. G06F 3/0485; G06F 3/0483

(52) U.S. Cl. CPC G06F 3/0485; G06F 3/0483

(57) ABSTRACT

Provided is an electronic device supporting fast scrolling and a method of operating same, the electronic device including: a display; a processor; and memory storing instructions, wherein the instructions, when executed by the processor, cause the electronic device to: display first content on the display; receive a user input for transitioning pages while displaying the first content; determine an input speed of the user input; determine a movement distance based on the input speed; identify source pages based on the movement distance; identify whether second content having a defined condition is included in the source pages; based on the second content being included in the source pages, generate a merged page based on the source pages, wherein the merged page includes an emphasis on the second content; and display the merged page by scrolling based on a direction of the user input.

### CROSS-REFERENCE TO RELATED APPLICATIONS

This application is a by-pass continuation of International Application No. PCT/KR2025/009600, filed on Jul. 4, 2025, which is based on and claims priority to Korean Patent Application No. 10-2024-0089815, filed on Jul. 8, 2024, in the Korean Intellectual Property Office, and Korean Patent Application No. 10-2024-0115393, filed on Aug. 27, 2024, in the Korean Intellectual Property Office, the disclosure of each of which is incorporated by reference herein in its entirety.

### BACKGROUND

### 1. Field

The disclosure relates to an electronic device supporting fast scroll, an operation method thereof, and a corresponding recording medium.

### 2. Description of Related Art

Recently, wearable electronic devices that can be worn on users' bodies (e.g., wrists) have been widely used. Wearable electronic devices may be an electronic device that is miniaturized and lightweight so as to be worn on the user's body (e.g., wrist). For these wearable electronic devices, the hardware and/or software aspects are continuously being researched to support and enhance their functions.

In the case of a wearable electronic device, the screen displayed through the display may be provided in units of pages. For example, categories of functions such as notifications, tiles, widgets, and/or smart stacks may be provided by dividing them into pages. The screen displayed on the display is divided into pages, and the user may navigate one page at a time with each input. Hence, when navigating pages on a wearable electronic device, the user may navigate through many pages in sequence one page at a time, making it difficult for the user to quickly navigate to the desired page.

### SUMMARY

Provided is an electronic device supporting fast scroll for fast movement between pages (or tiles) and thus improving navigation usability, an operation method thereof, and a corresponding recording medium.

Further provided is an electronic device that merges multiple pages based on the input speed of user input (e.g., scrolling speed) and supports fast scrolling based on the merged page, an operation method thereof, and a corresponding recording medium.

Further provided is an electronic device that supports displaying specified content with a highlight during fast scrolling, an operation method thereof, and a corresponding recording medium.

According to an aspect of the disclosure, an electronic device includes: a display; at least one processor including processing circuitry; and memory storing instructions, wherein the instructions, when executed individually or collectively by the at least one processor, cause the electronic device to: display first content on the display; receive a user input for transitioning pages while displaying the first content; determine an input speed of the user input; determine a movement distance based on the input speed; identify source pages based on the movement distance; identify whether at least one second content having a defined condition is included in at least one of the source pages; based on the at least one second content being included in at least one of the source pages, generate a merged page based on the source pages, wherein the merged page includes an emphasis on the at least one second content; and display the merged page by scrolling based on a direction of the user input.

The user input may include a first input having a specified speed related to transitioning over multiple pages, and a second input related to transitioning on a page basis; and the instructions, when executed individually or collectively by the at least one processor, may further cause the electronic device to: perform scrolling of the merged page in a specified direction based on the first input, and perform paging of another page, not included in the merged page, in a specified direction based on the second input.

The instructions, when executed individually or collectively by the at least one processor, may further cause the electronic device to display the at least one second content in a highlighted manner based on a specified effect while scrolling the merged page; and the specified effect may include at least one of slowing down a movement speed of a portion of the merged page corresponding to the at least one second content, slowing down the movement speed based on margins on both sides of the portion of the merged page, displaying edge highlighting, or haptic output.

The instructions, when executed individually or collectively by the at least one processor, may further cause the electronic device to: evaluate the defined condition, determine whether the at least one second content having the defined condition is included in at least one of the source pages based on content of the source pages, and based on the at least one second content being included in at least one of the source pages, mark at least one page corresponding to the at least one second content among the source pages.

The defined condition may include a criterion for determining a factor related to importance of content; and the instructions, when executed individually or collectively by the at least one processor, may further cause the electronic device to evaluate the defined condition based on a user's context, a presence or absence of an update, an amount of information in content, a notification trigger, or a user's preference.

The instructions, when executed individually or collectively by the at least one processor, may further cause the electronic device to set a specified margin in the marked at least one page when generating the merged page; and the marking may include location information for identifying a page among the source pages on which the at least one second content is located.

The instructions, when executed individually or collectively by the at least one processor, may further cause the electronic device to: identify a marked page while scrolling the merged page, and adjust a scroll speed based on the marked page.

The instructions, when executed individually or collectively by the at least one processor, may further cause the electronic device to: based on the merged page including a start page of the source pages and an end page of the source pages, display, on the display, the start page, display a start page portion of the merged page with a specified transition effect in response to the user input, scroll from the start page portion to an end page portion of the merged page, and display the end page with a specified transition effect upon reaching the end page portion.

The instructions, when executed individually or collectively by the at least one processor, may further cause the electronic device to generate the merged page based on pages between a start page and an end page of the source pages.

The instructions, when executed individually or collectively by the at least one processor, may further cause the electronic device to merge the source pages prior to receipt of the user input based on the defined condition.

The instructions, when executed individually or collectively by the at least one processor, may further cause the electronic device to: monitor the defined condition for content, merge the source pages to generate an image based on detecting the defined condition, and update the merged page using the generated image, and the defined condition may include at least one of an update related to content causing a change in data of the content, or a the display being turned on or turned off.

According to an aspect of the disclosure, a method of operating an electronic device include: displaying first content on a display of the electronic device; receiving a user input for transitioning pages while displaying the first content; determining an input speed of the user input; determining a movement distance based on the input speed; identifying source pages based on the movement distance; identifying whether at least one second content having a defined condition is included in at least one of the source pages; based on the at least one second content being included in at least one of the source pages, generating a merged page based on the source pages, wherein the merged page includes an emphasis on the at least one second content; and displaying the merged page by scrolling based on a direction of the user input.

The user input may include a first input having a specified speed related to transitioning over multiple pages, and a second input related to transitioning on a page basis, and the method may further include: performing scrolling of the merged page in a specified direction based on the first input; and performing paging of another page, not included in the source pages, in a specified direction based on the second input.

The displaying the merged page by scrolling may include displaying the at least one second content in a highlighted manner based on a specified effect while scrolling the merged page, and the specified effect may include at least one of slowing down a movement speed of a portion of the merged page corresponding to the at least one second content, slowing down the movement speed based on margins on both sides of the portion of the merged page, displaying edge highlighting, or haptic output.

The method may further include: evaluating the defined condition; determining whether the at least one second content having the defined condition is included in at least one of the source pages based on content of the source pages; and based on the at least one second content being included in at least one of the source pages, marking at least one page corresponding to the at least one second content among the source pages.

The defined condition may include a criterion for determining a factor related to importance of content, and the method may further include evaluating the defined condition based on a user's context, a presence or absence of an update, an amount of information in content, a notification trigger, or a user's preference.

The marking may include location information for identifying a page among the source pages on which the at least one second content is located, and the method may further include setting a specified margin in the marked at least one marked when generating the merged page.

The method may further include: identifying a marked page while scrolling the merged page; and adjusting a scroll speed based on the marked page.

The generating the merged page may include generating the merged page by including a start page and an end page of the source pages, or generating the merged page based on pages between the start page and the end page of the source pages, and the method may further include merging the source pages prior to receipt of the user input based on the defined condition.

According to an aspect of the disclosure, a non-transitory computer-readable medium has instructions stored therein, which when executed by at least one processor of an electronic device, cause the at least one processor to execute a method of operating the electronic device, the method including: displaying first content on a display of the electronic device; receiving a user input for transitioning pages while displaying the first content; determining an input speed of the user input; determining a movement distance based on the input speed; identifying source pages based on the movement distance; identifying whether at least one second content having a defined condition is included in at least one of the source pages; based on the at least one second content being included in at least one of the source pages, generating a merged page based on the source pages, wherein the merged page includes an emphasis on the at least one second content; and displaying the merged page by scrolling based on a direction of the user input.

According to an aspect of the disclosure, an electronic device includes: a display; at least one processor including processing circuitry; and memory storing instructions, wherein the instructions, when executed individually or collectively by the at least one processor, cause the electronic device to: display first content on the display; receive a user input for transitioning pages while displaying the first content; determine an input speed of the user input; and determine a movement distance based on the input speed, and wherein the instructions, when executed individually or collectively by the at least one processor, further cause the electronic device to, based on the input speed being greater than or equal to a threshold: identify source pages based on the movement distance; identify whether at least one second content having a defined condition is included in at least one of the source pages; based on the at least one second content being included in at least one of the source pages, generate a merged page based on the source pages, wherein the merged page includes an emphasis on the at least one second content; and display the merged page by scrolling based on a direction of the user input.

According to the electronic device, operation method thereof, and recording medium in accordance with one and more embodiments of the disclosure, a plurality of pages may be merged based on the input speed (e.g., scrolling speed) of user input, and fast scrolling may be supported based on the merged page. In one and more embodiments, multiple pages may be scrolled at once to thereby improve the user's navigation usability. In one and more embodiments, the navigation usability can be improved by emphasizing the specified content during fast scrolling (e.g., controlling the scroll speed, applying margins, applying highlighting, and/or applying haptics (or vibration)) to make it easier for the user to recognize the desired page.

In addition, various effects that can be directly or indirectly understood through this document may be provided. The effects obtainable from the disclosure are not limited to those mentioned above, and other effects not mentioned will be clearly understood by a person skilled in the art to which the disclosure belongs from the description below.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram of an electronic device in a network environment according to one and more embodiments;

FIG. 2 is a front perspective view of a wearable electronic device having a wrist-wearable structure according to one and more embodiments of the disclosure;

FIG. 3 is a rear perspective view of the wearable electronic device having a wrist-wearable structure according to one and more embodiments of the disclosure;

FIG. 4 is a view illustrating an example of a wearable electronic device according to one and more embodiments of the disclosure;

FIG. 5 is a diagram showing an example of the screen of a wearable electronic device according to one and more embodiments of the disclosure;

FIG. 6 is a schematic diagram illustrating the structure of an electronic device according to one and more embodiments of the disclosure;

FIG. 7 is a flowchart illustrating an operation method of the electronic device according to one and more embodiments of the disclosure;

FIG. 8 is a diagram illustrating an example of transitioning pages based on user input in the electronic device according to one and more embodiments of the disclosure;

FIG. 9 is a flowchart illustrating an operation method of the electronic device according to one and more embodiments of the disclosure;

FIG. 10 is a diagram illustrating an example of transitioning pages based on user input in the electronic device according to one and more embodiments of the disclosure;

FIGS. 11A and 11B are flowcharts illustrating an operation method of the electronic device according to one and more embodiments of the disclosure;

FIG. 12A is a diagram illustrating an example of page merging in the electronic device according to one and more embodiments of the disclosure;

FIG. 12B is a diagram illustrating an example of page merging in the electronic device according to one and more embodiments of the disclosure;

FIG. 13 is a diagram illustrating an example of page merging in the electronic device according to one and more embodiments of the disclosure;

FIG. 14 is a diagram illustrating an example of page merging in the electronic device according to one and more embodiments of the disclosure;

FIGS. 15A, 15B and 15C are diagrams illustrating various examples of page merging in the electronic device according to one and more embodiments of the disclosure;

FIG. 16 is a diagram illustrating an example of transitioning pages in the electronic device according to one and more embodiments of the disclosure;

FIG. 17 is a diagram illustrating an example of presenting content in an emphasized manner in the electronic device according to one and more embodiments of the disclosure;

FIG. 18 is a diagram illustrating an example of presenting content in an emphasized manner in the electronic device according to one and more embodiments of the disclosure;

FIG. 19 is a diagram illustrating an example of presenting content in an emphasized manner in the electronic device according to one and more embodiments of the disclosure;

FIG. 20 is a diagram illustrating an example of presenting content in an emphasized manner in the electronic device according to one and more embodiments of the disclosure;

FIG. 21 is a diagram illustrating an example of presenting content in an emphasized manner in the electronic device according to one and more embodiments of the disclosure;

FIG. 22 is a diagram illustrating an example of presenting content in an emphasized manner in the electronic device according to one and more embodiments of the disclosure;

FIG. 23 is a diagram illustrating an example of presenting content in an emphasized manner in the electronic device according to one and more embodiments of the disclosure;

FIG. 24 is a diagram illustrating an example of presenting content in an emphasized manner in the electronic device according to one and more embodiments of the disclosure;

FIG. 25 is a diagram illustrating an example of presenting content in an emphasized manner in the electronic device according to one and more embodiments of the disclosure; and

FIG. 26 is a diagram illustrating an example of providing indicators corresponding to page merging in the electronic device according to one and more embodiments of the disclosure.

### DETAILED DESCRIPTION

Hereinafter, embodiments of the disclosure will be described in detail with reference to the drawings so that those skilled in the art to which the disclosure pertains can readily carry out the disclosure. However, the disclosure may be implemented in various different forms and is not limited to the embodiments described herein. In connection with the description of the drawings, the same or similar reference symbols may be used for identical or similar components. Additionally, in the drawings and related descriptions, descriptions of well-known functions and configurations may be omitted for clarity and brevity.

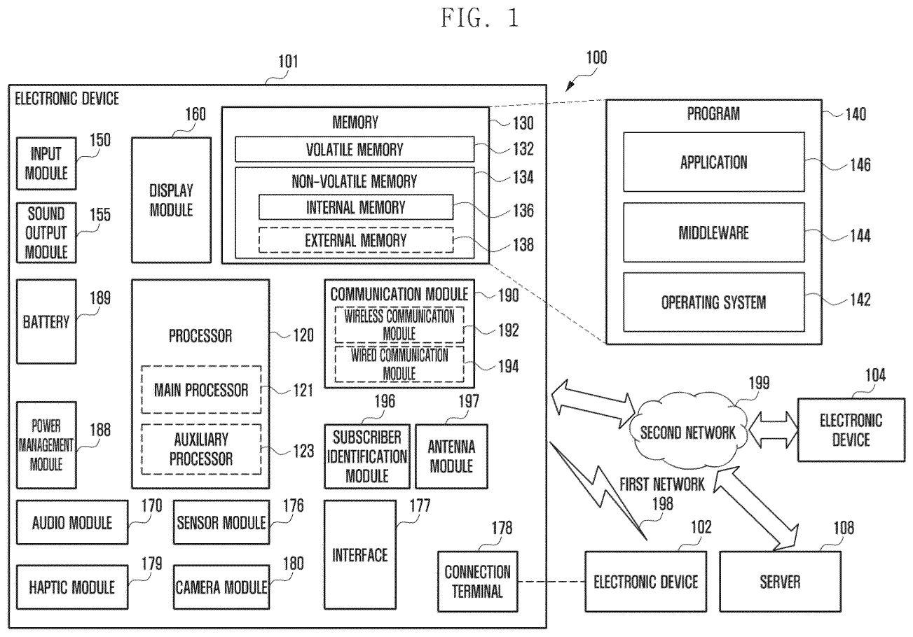

FIG. 1 is a block diagram illustrating an electronic device 101 in a network environment 100 according to one and more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to one and more embodiments, the electronic device 101 may communicate with the electronic device 104 via the server 108. According to one and more embodiments, the electronic device 101 may include a processor 120, memory 130, an input 1module 150, a sound output 1module 155, a display 1module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the 11connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). 11

The processor 120 may execute, for example, software (e.g., a program 140) to control at least one other component (e.g., a hardware or software component) of the electronic device 101 coupled with the processor 120, and may perform various data processing or computation. According to one and more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to one and more embodiments, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display 1module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one and more embodiments, the auxiliary processor 123 (e.g., an image signal processor or a communication processor) may be implemented as part of another component (e.g., the camera module 180 or the communication module 190) functionally related to the auxiliary processor 123. According to one and more embodiments, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input 1module 150 may include, for example, a microphone, a mouse, a keyboard, a key (e.g., a button), or a digital pen (e.g., a stylus pen).

The sound output module 155 may output sound signals to the outside of the electronic device 101. The sound output 1module 155 may include, for example, a speaker or a receiver. The speaker may be used for general purposes, such as playing multimedia or playing record. The receiver may be used for receiving incoming calls. According to one and more embodiments, the receiver may be implemented as separate from, or as part of the speaker.

The display module 160 may visually provide information to the outside (e.g., a user) of the electronic device 101. The display 1module 160 may include, for example, a display, a hologram device, or a projector and control circuitry to control a corresponding one of the display, hologram device, and projector. According to one and more embodiments, the display 1module 160 may include a touch sensor adapted to detect a touch, or a pressure sensor adapted to measure the intensity of force incurred by the touch.

The audio module 170 may convert a sound into an electrical signal and vice versa. According to one and more embodiments, the audio module 170 may obtain the sound via the input 1module 150, or output the sound via the sound output 1module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to one and more embodiments, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to one and more embodiments, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to one and more embodiments, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to one and more embodiments, the haptic module 179 may include, for example, a motor, a piezoelectric element, or an electric stimulator.

The camera module 180 may capture a still image or moving images. According to one and more embodiments, the camera module 180 may include one or more lenses, image sensors, image signal processors, or flashes.

The power management module 188 may manage power supplied to the electronic device 101. According to one and more embodiments, the power management module 188 may be implemented as at least part of, for example, a power management integrated circuit (PMIC).

The battery 189 may supply power to at least one component of the electronic device 101. According to one and more embodiments, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to one and more embodiments, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to one and more embodiments, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to one and more embodiments, the antenna module 197 may include an antenna including a radiating element composed of a conductive material or a conductive pattern formed in or on a substrate (e.g., a printed circuit board (PCB)). According to one and more embodiments, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to one and more embodiments, another component (e.g., a radio frequency integrated circuit (RFIC)) other than the radiating element may be additionally formed as part of the antenna module 197.

According to one and more embodiments, the antenna module 197 may form a mmWave antenna module. According to one and more embodiments, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) there between via an inter-peripheral communication scheme (e.g., a bus, general purpose input and output (GPIO), serial peripheral interface (SPI), or mobile industry processor interface (MIPI)).

According to one and more embodiments, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to one and more embodiments, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to one and more embodiments, the external electronic device 104 or the server 108 may be included in the second network 199. The electronic device 101 may be applied to intelligent services (e.g., smart home, smart city, smart car, or healthcare) based on 5G communication technology or IoT-related technology.

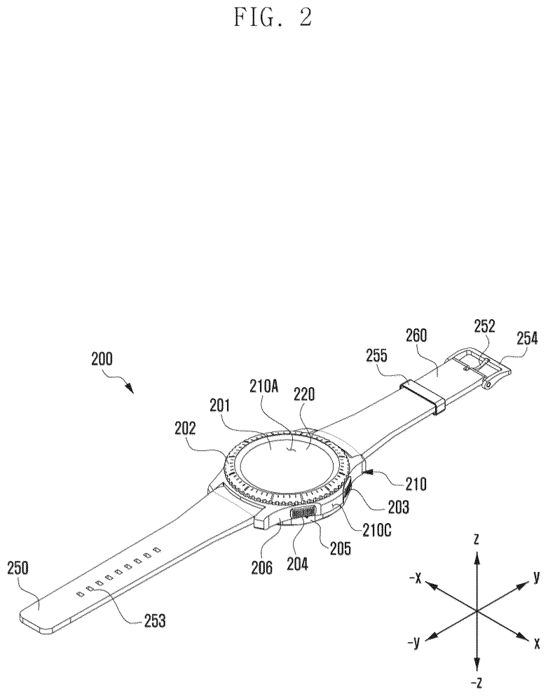

FIG. 2 is a front perspective view of a wearable electronic device having a wrist-wearable structure according to one and more embodiments of the disclosure.

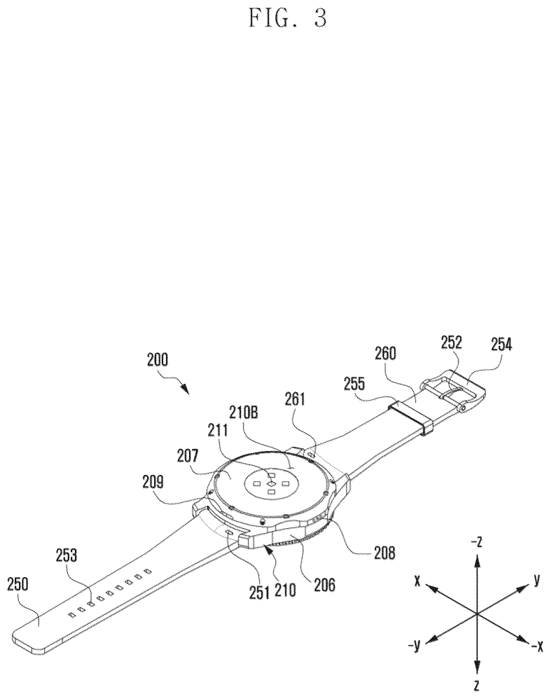

FIG. 3 is a rear perspective view of the wearable electronic device having a wrist-wearable structure according to one and more embodiments of the disclosure.

The wearable electronic device 200 of FIGS. 2 and 3 may be at least partially similar to the electronic device 101 in FIG. 1, may include the electronic device 101 in FIG. 1, or may further include other embodiments of the electronic device 101. For example, the wearable electronic device 200 may include a wearable device (e.g., wearable watch) that can be worn on a part of the human body (e.g., wrist).

With reference to FIGS. 2 and 3, the wearable electronic device 200 according to one and more embodiments may include: a housing 210 including a first surface (or, front surface, surface seen from above (e.g., −z direction)) 210A, a second surface (or, rear surface, surface seen from below (e.g., z direction)) 210B, and a side surface 210C surrounding the space between the first surface 210A and the second surface 210B; and fastening members 250 and 260 (e.g., strap, connection member and/or coupling member) connected to at least a portion of the housing 210 and configured to detachably fasten the electronic device 200 to a body part (e.g., wrist) of the user.

In one and more embodiments, the fastening members 250 and 260 may be, for example, a strap that wraps around the user's wrist to secure the electronic device 200. The fastening members 250 and 260 may be made of various materials and formed in various shapes. The fastening member 250 or 260 may be formed integrally, for example, by a woven material, leather, rubber, synthetic resin, metal, ceramic, or a combination of these materials, or may be formed by a plurality of unit links that are movable with each other.

In one and more embodiments, the housing 210 may refer to a structure forming some of the first surface 210A, the second surface 210B, and the side surface 210C of the wearable electronic device 200. The housing 210 may have various shapes other than the illustrated circular shape (e.g., square, round square).

According to one and more embodiments, the first surface 210A may be formed by a front plate 201 that is substantially transparent at least in part (e.g., glass plate containing various coating layers, or polymer plate). The second surface 210B may be formed by a rear plate 207 that is substantially opaque. The rear plate 207 may be made of, for example, coated or colored glass, ceramic, polymer, metal (e.g., aluminum (Al), stainless steel (STS), or magnesium), or a combination thereof. The side surface 210C may be coupled to the front plate 201 and the rear plate 207 and may be formed by a lateral bezel structure (or, lateral member) 206 containing metal and/or polymer. In one and more embodiments, the rear plate 207 and the lateral bezel structure 206 may be integrally formed and contain the same material (e.g., metal material such as aluminum).

According to one and more embodiments, the wearable electronic device 200 may include at least one of a display 220 (e.g., display module 160 in FIG. 1), audio modules 205 and 208 (e.g., audio module 170 in FIG. 1), a sensor module 211 (e.g., sensor module 176 in FIG. 1), key input devices 202, 203 and 204 (e.g., input module 150 in FIG. 1), or a connector hole 209 (e.g., connection terminal 176 in FIG. 1). In one and more embodiments, in the wearable electronic device 200, at least one of the components (e.g., key input devices 202, 203 and 204, connector hole 209, and/or sensor module 211) may be omitted or other components may be additionally included. According to one and more embodiments, the components are not limited to those illustrated in FIGS. 2 and 3. For example, the wearable electronic device 200 may include a processor (e.g., processor 120 in FIG. 1), a memory (e.g., memory 130 in FIG. 1), an FPCB, a communication circuit (e.g., communication module 190 in FIG. 1), a battery (e.g., battery 189 in FIG. 1), a power management integrated circuit (PMIC) (e.g., power management module 188 in FIG. 1), and an antenna module (e.g., antenna module 197 in FIG. 1).

The display 220 may be visually exposed through a significant portion of the front plate 201. For example, the user may identify at least one content displayed on the display 220 through the front plate 201. The shape of the display 220 may correspond to the shape of the front plate 201, and may be one of circular, oval, square, and/or polygonal shapes. The display 220 may be at least partially coupled to, or disposed adjacent to, a touch sensing circuit, a pressure sensor capable of measuring the intensity (e.g., pressure) of a touch, and/or a fingerprint sensor.

The audio modules 205 and 208 may include a microphone hole 205 and a speaker hole 208. In the microphone hole 205, a microphone for picking up external sounds may be disposed therein. In one and more embodiments, the microphone may include plural microphones arranged to sense the direction of a sound. The speaker hole 208 may be used for an external speaker and a call receiver. In one and more embodiments, the speaker hole 208 and the microphone hole 205 may be implemented as a single hole, or a speaker (e.g., piezo speaker) may be included without the speaker hole 208.

The sensor module 211 may generate an electric signal or data value in correspondence to an internal operation state of the wearable electronic device 200 or an external environmental state. The sensor module 211 may include a biometric sensor module (e.g., biometric sensor, heart rate monitor (HRM) sensor, oxygen saturation sensor, and/or blood glucose sensor) disposed toward the second surface 210B of the housing 210. When the wearable electronic device 200 is worn on a body part (e.g., wrist), the sensor module 211 may be arranged so as to at least partially contact the human body. The wearable electronic device 200 may further include at least one of sensor modules, such as a gesture sensor, a gyro sensor, a barometer sensor, a magnetic sensor (e.g., Hall sensor or Hall IC), an acceleration sensor, a grip sensor, a color sensor (e.g., red, green, blue (RGB) sensor), an infrared (IR) sensor, a temperature sensor, a humidity sensor, an illuminance sensor (e.g., ambient light sensor (ALS)), and/or an electrode sensor.

The key input devices 202, 203 and 204 may include an annular member (or, wheel key, bezel housing, rotatable wheel) 202 arranged corresponding to the first surface 210A of the housing 210 and rotatable along at least one direction (e.g., clockwise, counterclockwise), and/or side key buttons 203 and 204 arranged on the side surface 210C of the housing 210. The annular member 202 may have a shape corresponding to the shape of the front plate 201. The annular member 202 may rotate clockwise or counterclockwise about the center of the display 220. The key buttons 203 and 204 may include a physical button, a crown (e.g., watch crown), or a sensor that responds to a touch or pressure. The key buttons 203 and 204 may include a metal through which an electrical signal is transmitted. Hence, the key buttons 203 and 204 may be utilized as an interface for the electrode sensor. According to one and more embodiments, the wearable electronic device 200 may not include some or all of the key input devices 202, 203 and 204 described above, and the key input device 202, 203 or 204 that is not included may be implemented in the form of a soft key and/or a touch key on the display 220.

The connector hole 209 may accommodate a connector (e.g., USB connector) for transmitting and receiving power and/or data to and from an external electronic device (e.g., smartphone or travel adapter (TA). The connector hole 209 may include another connector hole that can accommodate a connector for transmitting and receiving an audio signal to and from an external electronic device. The wearable electronic device 200 may further include, for example, a connector cover that covers at least a portion of the connector hole 209 and blocks foreign substances from entering the connector hole 209.

The fastening members 250 and 260 may be detachably fastened to at least a portion of the housing 210 by using locking members 251 and 261. The fastening members 250 and 260 may include at least one of a fixing member 252, fixing member fastening holes 253, a band guide member 254, or a band fixing ring 255. According to one and more embodiments, the wearable electronic device 200 may remain at least partially attached to the body part (e.g., wrist) by using the fastening members 250 and 260.

The fixing member 252 may be at least partially coupled with the fixing member fastening holes 253 so that the housing 210 and the fastening members 250 and 260 are fixed to a part of the user's body (e.g., wrist). The fixing member fastening holes 253 may fix the housing 210 and the fastening members 250 and 260 to a body part of the user in correspondence to the fixing member 252. The band guide member 254 may be configured to limit the range of movement of the fixing member 252 when the fixing member 252 engages with a fixing member fastening hole 253, and the fastening members 250 and 260 may be fastened in close contact to a body part of the user, thereby fastening the wearable electronic device 200 to the body part. The band fixing ring 255 may limit the range of movement of the fastening members 250 and 260 while the fixing member 252 and the fixing member fastening hole 253 are fastened.

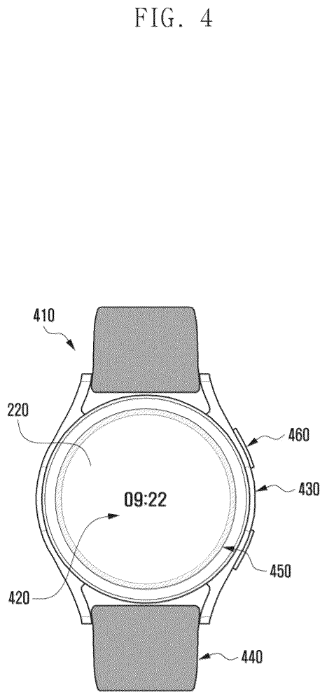

FIG. 4 is a view illustrating an example of a wearable electronic device according to one and more embodiments of the disclosure.

In one and more embodiments, the wearable electronic device of FIG. 4 may be at least partially similar to the electronic device 101 and/or the wearable electronic device 200 of FIGS. 1 to 3, or may include the electronic device 101 and/or the wearable electronic device 200 of FIGS. 1 to 3. For example, the wearable electronic device may include a wearable device (e.g., wearable watch) that can be worn on a part of the human body (e.g., wrist). According to one and more embodiments, the wearable electronic device may be implemented by including at least some of the components in FIGS. 1 to 3, or by additionally including other components.

In one and more embodiments, the wearable electronic device may include a display 220 (e.g., display module 160 in FIG. 1 or display 220 in FIGS. 2 and 3) on the front surface 410 (e.g., first surface 210A in FIGS. 2 and 3). The wearable electronic device may be a wearable electronic device (e.g., wearable watch) that can be worn by the user in the form of a watch. The wearable electronic device may display a watch-related interface 420 on at least a portion of the display 220.

In one and more embodiments, the wearable electronic device may include a case 430 (e.g., housing 210 in FIGS. 2 and 3) and a band (or, strap) 440 (e.g., fastening member 250 or 260 in FIG. 2 or 3).

In one and more embodiments, the case 430 may include, on the outside, a bezel 450 (e.g., lateral bezel structure 206 in FIGS. 2 and 3), a crown 460 (e.g., input module 150 in FIG. 1 or side key buttons 203 and 204 in FIGS. 2 and 3), and a display 220. The case 430 may include, internally or externally, the processor 120, the memory 130, the input module 150, the sound output module 155, the display module 160, the audio module 170, the sensor module 176, the interface 177, the connection terminal 178, the haptic module 179, the camera module 180, the power management module 188, the battery 189, the communication module 190, the subscriber identification module 196, and/or the antenna module 197, which are illustrated in FIG. 1.

In one and more embodiments, the display 220 may be disposed on the front surface 410 of the case 430, and at least a portion (e.g., biometric sensor module) of the sensor circuit (e.g., sensor module 211 in FIGS. 2 and 3) may be exposed to the outside on the rear surface (e.g., second surface 210B in FIGS. 2 and 3).

In one and more embodiments, the rear surface of the case 430 may be at least partially in contact with the user when the wearable electronic device is worn by the user via the band 440.

In one and more embodiments, the bezel 450 may be in a ring shape concentric with the circular display 220. The inner radius of the bezel 450 may be the same as the radius of the display 220. The bezel 450 may be placed on the edge of the case 430 to protect the display 220 from external impact.

In one and more embodiments, the bezel 450 may be rotated in at least one of clockwise direction or counterclockwise direction. The bezel 450 may serve as an input device of the wearable electronic device. When the bezel 450 is rotated, the wearable electronic device may recognize the speed and/or direction of rotation of the bezel 450 as user input and control its function according to the user input.

In one and more embodiments, the crown 460 may be disposed to protrude from at least a portion of the case 430. The crown 460 may have one of the shapes of a circular cylinder, an elliptical cylinder, a square cylinder, or a polygonal cylinder. The crown 460 may be rotated around the rotation axis and be connected to the case 430. The crown 460 may be connected through the stem providing the rotation axis to the case 430 and be rotated. Without being limited thereto, the crown 460 may be in the form of a key button (e.g., side key button 203 or 240 in FIG. 2 or 3).

In one and more embodiments, the crown 460 may serve as an input device of the wearable electronic device. When the crown 460 is rotated, the wearable electronic device may recognize the speed and/or direction of rotation of the crown 460 as user input and control its function according to the user input. In one and more embodiments, if the crown 460 is in the form of a key button, when the crown 460 is pressed, the wearable electronic device may recognize the number of times the crown 460 is pressed or the duration it is pressed as user input, and control its function according to the user input.

In one and more embodiments, the band 440 may enable the wearable electronic device to be worn on the user's wrist. The band 440 may be made of various materials such as metal, rubber, and leather. The band 440 may be connected to one end of the case 430, and the band 440 connected to the case 430 may be replaced.

According to one and more embodiments, the wearable electronic device may include, internally, at least one of an input device (e.g., microphone), a sound output device, a sensor module, a camera device, a key input device, a communication circuit, and/or a connector port.

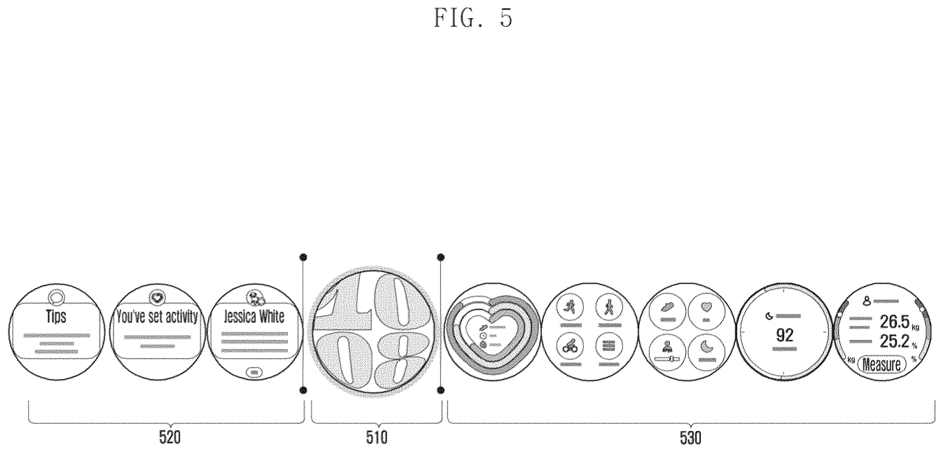

FIG. 5 is a diagram showing an example of the screen of a wearable electronic device according to one and more embodiments of the disclosure.

According to one and more embodiments, FIG. 5 may illustrate an example of a screen configuration presented through the display in the wearable electronic device.

As illustrated in FIG. 5, the screen configuration of the wearable electronic device (e.g., electronic devices 101 and 200 of FIGS. 1 to 4) may be divided into three sections 510, 520 and 530 according to, for example, the properties of content (e.g., notification, clock, or application (or, widget)). For example, the wearable electronic device may provide a screen configuration that is divided into three sections, such as a first section 510 for first content, a second section 520 for at least one second content, and a third section 530 for at least one third content.

According to one and more embodiments, the first section 510 may be a section for a screen (e.g., watch screen, watch face, or home screen) related to the first content (e.g., watch content). According to one and more embodiments, the first section 510 may provide a screen (e.g., watch screen, watch face, or home screen) related to a watch set by the user (e.g., analog type watch UX/UI, or digital type watch UX/UI). In one and more embodiments, the first section 510 may be defined as one page (or, tile) for the first content.

According to one and more embodiments, the second section 520 may be a section for a screen (e.g., notification screen) related to the second content (e.g., notification content). According to one and more embodiments, the second section 520 may provide a screen (e.g., notification screen) related to a notification (e.g., message notification, call notification, messenger notification) obtained (or received) by the wearable electronic device from an external device (e.g., server (e.g., server 108 in FIG. 1) and/or external electronic device (e.g., electronic device 102 in FIG. 1)), and/or related to a notification detected (or measured) by the wearable electronic device (e.g., sleep record notification, weather notification). In one and more embodiments, the second section 520 may be defined as at least one page (or, tile, widget, or smart stack) corresponding to the second content (e.g., notification) received from the outside (e.g., external device) and/or generated internally in the wearable electronic device. For example, if N (e.g., N is a natural number) notifications are triggered in the wearable electronic device, the second section 520 may include N pages, and notification screens corresponding respectively to the N notifications may be provided on a page basis through the N pages.

According to one and more embodiments, the third section 530 may be a section for a screen (e.g., content screen) related to the third content (e.g., content related to an application (or widget)). According to one and more embodiments, the third section 530 may provide a screen (e.g., content screen) associated with an interface (e.g., UX/UI corresponding to an application (or, widget)) related to an application (or widget) configured (added or installed) by the user on the wearable electronic device. In one and more embodiments, the third section 530 may be defined as at least one page (or, tile) corresponding to the settings of the wearable electronic device. For example, if M (e.g., M is a natural number) applications (or, widgets) are configured on the wearable electronic device, the third section 530 may include M pages, and content screens corresponding respectively to the M applications (or, widgets) may be provided on a page basis through the M pages.

In one and more embodiments, the number of pages (e.g., N) in the second section 520 and the number of pages (e.g., M) in the third section 530 may be the same or different. For example, the values of N and M may be the same or different.

As illustrated in FIG. 5, the wearable electronic device may include a structure of second section 520 (e.g., notification section)—first section 510 (e.g., watch face section)—third section 530 (e.g., content section). According to one and more embodiments, all screens of the first section 510, the second section 520, and the third section 530 may be divided into pages (or, tiles), and may be navigated on a page basis (or, paging) (e.g., one page at a time) and/or navigated (or, scrolled) on a merged page basis (e.g., grouped pages, bundled pages, or multiple pages at a time) according to user input (e.g., flick (or, fast swipe), or swipe (or, slow swipe)).

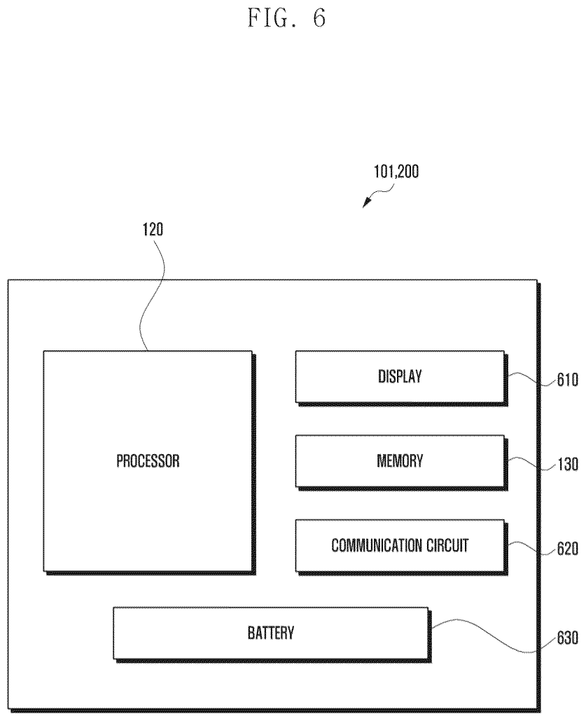

FIG. 6 is a schematic diagram illustrating the structure of an electronic device according to one and more embodiments of the disclosure.

In one and more embodiments, the electronic device 101 or 200 of FIG. 6 may be at least partially similar to the electronic device 101 and/or the wearable electronic device 200 of FIGS. 1 to 5, or may include the electronic device 101 and/or the wearable electronic device 200 of FIGS. 1 to 5.

With reference to FIG. 6, the electronic device 101 or 200 according to one and more embodiments may include a display 610 (e.g., display module 160 in FIG. 1 or display 220 in FIGS. 2 to 4), a memory 130 (e.g., memory 130 in FIG. 1), a communication circuit 620 (e.g., communication module 190 in FIG. 1), a battery 630 (e.g., battery 189 in FIG. 1), and/or a processor 120 (e.g., processor 120 in FIG. 1). According to one and more embodiments, the electronic device 101 or 200 may include all or at least some of the components of the electronic devices 101 and 200 described with reference to FIGS. 1 to 5. For example, in embodiments of this document, some of the illustrated components may be omitted or replaced. The electronic device 101 or 200 may include at least some of the configurations and/or functions of the electronic device 101 of FIG. 1 and/or the electronic device 200 of FIGS. 2 to 5. At least some of the components of the electronic device 101 or 200 may be operably, functionally and/or electrically connected to each other.

According to one and more embodiments, the display 610 may include the same or similar configuration as the display module 160 in FIG. 1 and/or the display 220 in FIGS. 2 to 4. According to one and more embodiments, the display 610 may display various images provided from the processor 120. According to one and more embodiments, the display 610 may visually present a running application (or, widget) (e.g., application 146 in FIG. 1) and various screens related to its use (e.g., home screen (e.g., watch face), content screen, notification screen, and/or function execution screen) under the control of the processor 120. For example, the display 610 may display various screens related to a notification, watch, and content, as illustrated in FIG. 5.

In one and more embodiments, the display 610 may be combined with a touch sensor, a pressure sensor capable of measuring the intensity of a touch, and/or a touch panel (e.g., digitizer) that detects a stylus pen using a magnetic field scheme. According to one and more embodiments, the display 610 may detect touch input, air gesture input, and/or hovering input (or, proximity input) by measuring changes in signals (e.g., voltage, light, resistance, electromagnetic signals, and/or charge) relative to a specific location of the display 610 based on the touch sensor, the pressure sensor, and/or the touch panel. For example, the display 610 may include a touchscreen that detects touch input and/or proximity touch (or hovering) input by using a part of the user's body (e.g., finger) or an input device (e.g., stylus pen). The display 610 may include at least some of the configurations and/or functions of the display module 160 in FIG. 1 and/or the display 220 in FIGS. 2 to 4.

According to one and more embodiments, the display 610 may include, but not limited to, a liquid crystal display (LCD), a light-emitting diode (LED) display, an organic light-emitting diode (OLED) display, an active matrix OLED (AMOLED) display, a micro electro mechanical systems (MEMS) display, or an electronic paper display.

According to one and more embodiments, the memory 130 may include at least some of the configurations and/or functions of the memory 130 in FIG. 1, and may store software (e.g., programs 140 in FIG. 1) and instructions.

According to one and more embodiments, the memory 130 may store various data used by at least one component (e.g., processor 120) of the electronic device 101 or 200. In one and more embodiments, the data may include, for example, software (e.g., programs 140 in FIG. 1), and input or output data for commands (or, instructions) associated with the software.

According to one and more embodiments, the memory 130 may include a volatile memory (e.g., volatile memory 132 in FIG. 1) or a nonvolatile memory 134 (e.g., nonvolatile memory 134 in FIG. 1). According to one and more embodiments, the memory 130 may store a command or data received from the processor 120 in the volatile memory 132, and store the result data obtained by the processor 120 having processed the command or data stored in the volatile memory 132 in the nonvolatile memory 134.

In one and more embodiments, the data may include various data related to the electronic device 101 or 200 for supporting transitioning between pages (or, tiles) based on user input (e.g., training data, context, configuration data, movement distance (or, page-merging range) based on input speed, and/or page-merging data). In one and more embodiments, the data may include information regarding various settings to assist the electronic device 101 or 200 in controlling page transitions based on user input.

In one and more embodiments, the data may include various training data and/or parameters obtained based on the user's training through interaction with the user. In one and more embodiments, the data may include various schemas (or, algorithms, models, networks, or functions) for learning the training data.

For example, the schemas for supporting training in the electronic device 101 or 200 may include neural networks. In one and more embodiments, the neural networks may include neural network models based on at least one of an artificial neural network (ANN), a convolution neural network (CNN), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a long short-term memory (LSTM) network, a classification network, a plain residual network, a dense network, a hierarchical pyramid network, and/or a fully convolutional network. In one and more embodiments, the type of neural network model is not limited to those described above.

In one and more embodiments, the memory 130 may store instructions that, when executed, cause the processor 120 (or, at least one processor 120) to operate. For example, the instructions may be stored as software (e.g., programs 140 of FIG. 1) in the memory 130 and be executed by the processor 120. For example, the instructions may include control commands that can be recognized by the processor 120, such as arithmetic and logical operations, data movement, and/or input/output. According to one and more embodiments, the software may include various applications (e.g., applications 146 in FIG. 1) that may provide various functions (or, services) (e.g., health function, weather function, call function, message function, messenger function, e-mail function, SNS (social networking service) function, search function, media (e.g., video and/or music) playback function, game function, and/or wireless communication function) on the electronic device 101 or 200.

According to one and more embodiments, the communication circuit 620 may support establishment of a designated wireless communication channel (e.g., short-range communication such as Bluetooth communication and/or BLE communication) and performance of communication through the established wireless communication channel. For example, the communication circuit 620 may perform designated communication (e.g., Bluetooth communication and/or BLE communication) with an external electronic device (e.g., electronic device 101 or electronic device 102 in FIG. 1). According to one and more embodiments, the communication circuit 620 may support wireless communication with an external electronic device by using cellular wireless communication (e.g., 4G LTE, 5G NR) and/or short-range wireless communication (e.g., Wi-Fi). According to one and more embodiments, the communication circuit 620 may include at least some of the configurations and/or functions of the communication module 190 in FIG. 1.

According to one and more embodiments, the battery 630 (e.g., battery 189 in FIG. 1) is a device for supplying power to at least one component of the electronic device 101 or 200, and may include, for example, at least one of a non-rechargeable primary battery, a rechargeable secondary battery, or a fuel cell. The battery 630 may be integrally arranged inside the electronic device 101 or 200 or may be detachably arranged from the electronic device 101 or 200.

According to one and more embodiments, the processor 120 may perform a processing function of the application layer requested by the user of the electronic device 101 or 200. According to one and more embodiments, the processor 120 may provide control and commands of functions for various components of the electronic device 101 or 200. According to one and more embodiments, the processor 120 may perform operations or data processing related to control and/or communication of individual components of the electronic device 101 or 200. For example, the processor 120 may include at least some of the configurations and/or functions of the processor 120 in FIG. 1. According to one and more embodiments, the processor 120 may be operably connected to the components of the electronic device 101 or 200. According to one and more embodiments, the processor 120 may load a command or data received from another component of the electronic device 101 or 200 onto the memory 130, process the command or data stored in the memory 130, and store result data in the memory 130.

In one and more embodiments, the processor 120 may include at least one processor including processing circuitry and/or executable program elements. According to one and more embodiments, the processor 120 may control (or, process) the overall operations associated with supporting transitioning between pages (or, tiles) according to user input, based on the processing circuitry and/or executable program elements.

According to one and more embodiments, the processor 120 may display the first content on the display. According to one and more embodiments, the processor 120 may receive a user input (e.g., flick or swipe touch gesture) for transitioning pages (or, tiles) while displaying the first content. According to one and more embodiments, the processor 120 may identify the input speed of the user input based on the user input. According to one and more embodiments, the processor 120 may determine the movement distance (or, paging section) based on the input speed. According to one and more embodiments, the processor 120 may set the page merge section based on the movement distance.

According to one and more embodiments, the processor 120 may identify at least one second content that satisfies a defined condition. According to one and more embodiments, the processor 120 may identify at least one second content (or, at least one emphasized content) that satisfies a defined condition (e.g., condition requiring emphasis) among pieces of content of source pages corresponding to the movement distance.

According to one and more embodiments, the processor 120 may merge the source pages based on the presence or absence of at least one second content. According to one and more embodiments, if the second content is present, the processor 120 may merge the source pages (e.g., generate a merged image) so that the second content is emphasized (e.g., emphasize a page where the second content is presented) in the source pages. According to one and more embodiments, if the second content is not present, the processor 120 may merge the source pages (e.g., generate a merged image) without content emphasis. According to one and more embodiments, the processor 120 may display the merged page (or, merged image) by scrolling based on the direction of the user input (e.g., leftward or rightward). According to one and more embodiments, the processor 120 may display at least one second content in an emphasized manner while scrolling the merged page.

According to one and more embodiments, the user input may include a first input (e.g., flick touch gesture) having a preset speed in association with transitioning over multiple pages (e.g., scrolling), and a second input (e.g., swipe touch gesture) associated with transitioning on a page basis (e.g., paging). According to one and more embodiments, the processor 120 may perform scrolling of a merged page based on the first input. According to one and more embodiments, the processor 120 may perform paging of another page in a specified direction based on the second input.

According to one and more embodiments, if the type of user input is a first input (e.g., flick touch gesture), the processor 120 may be configured to determine the input speed. According to one and more embodiments, if the type of user input is a second input (e.g., swipe touch gesture) other than a first input, the processor 120 may perform page transitioning without input speed determination.

According to one and more embodiments, the detailed operation of the processor 120 of the electronic device 101 or 200 is described with reference to the drawings below.

According to one and more embodiments, the processor 120 may be a system semiconductor device that is responsible for the operations and multimedia driving functions of the electronic device 101 or 200. According to one and more embodiments, the processor 120 may be configured in the form of a system-on-chip (SoC), and may include a technology-intensive semiconductor chip that integrates multiple semiconductor technologies into one and implements system blocks within a single chip.

According to one and more embodiments, the processor 120 may include an application processor (AP). According to one and more embodiments, the processor 120 may include components such as a graphics processing unit (GPU), an image signal processor (ISP), a central processing unit (CPU), a neural processing unit (NPU), a digital signal processor (DSP), a modem, connectivity, and/or security. According to one and more embodiments, the processor 120 may operate individually and/or collectively.

According to one and more embodiments, the operations performed by the processor 120 may be implemented by executing instructions stored in a recording medium (or, computer program product or storage medium). For example, the recording medium may include a non-transitory computer-readable recording medium in which a program for executing various operations performed by the processor 120 is recorded.

The embodiments described in the disclosure may be implemented in a computer or machine-readable recording medium by using software, hardware, or a combination thereof. For hardware implementation, the operations described in one and more embodiments may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for performing other functions.

In one and more embodiments, there is provided a computer-readable recording medium (or, computer program product) recording a program that causes the electronic device 101 or 200 to perform (or, execute) various operations.

The above operations may include an operation of displaying first content on the display, an operation of receiving a user input (e.g., flick or swipe touch gesture) for transitioning pages (or, tiles) while displaying the first content, an operation of determining the input speed of the user input based on the user input, an operation of determining a movement distance (or, paging section) based on the input speed, an operation of setting a page merge section based on the movement distance, an operation of determining at least one second content satisfying a defined condition, an operation of generating a merged image so that the second content is emphasized if the second content is present, an operation of merging source pages without content emphasis if the second content is not present, and an operation of displaying the merged page (or, merged image) with scrolling based on the direction of the user input (e.g., leftward or rightward). The above operations may include an operation of displaying at least one second content in a highlighted manner while scrolling the merged page.

The above operations may include an operation of displaying first content on the display, an operation of receiving a user input (e.g., flick or swipe touch gesture) for transitioning pages (or, tiles) while displaying the first content, an operation of determining the input speed of the user input based on the user input, an operation of determining a movement distance (or, paging section) based on the input speed, an operation of determining at least one second content satisfying a defined condition among pieces of content of source pages corresponding to the movement distance, an operation of merging source pages based on the presence or absence of at least one second content (e.g., merging source pages with the second content emphasized, or merging source pages without content emphasis), an operation of displaying the merged page by scrolling based on the direction of the user input (e.g., leftward or rightward), and an operation of displaying at least one second content in a highlighted manner while scrolling the merged page.

The electronic device (e.g., electronic device 101 or 200 of FIGS. 1 to 3) according to one and more embodiments of the disclosure may include a display (e.g., display module 160 in FIG. 1 or display 610 in FIG. 6), at least one processor (e.g., processor 120 in FIG. 1 or FIG. 6) including processing circuitry, and a memory (e.g., memory 130 in FIG. 1 or FIG. 6). In one and more embodiments, the memory may store instructions that, when executed individually and/or collectively by at least one processor, cause the electronic device 101 to perform corresponding operations.

According to one and more embodiments, the instructions, when executed by the at least one processor, may cause the electronic device to display first content on the display, receive a user input for transitioning pages while displaying the first content, determine the input speed of the user input based on the user input, determine a movement distance based on the input speed, set source pages (or page merge section) based on the movement distance, identify whether at least one second content having a defined condition is included in pieces of content of the source pages, generate, if at least one second content is present, a merged image such that the at least one second content is emphasized, and display the merged page by scrolling based on the direction of the user input.

In one and more embodiments, the user input may include a first input having a preset speed related to transitioning over multiple pages, and a second input related to transitioning on a page basis.

According to one and more embodiments, the instructions, when executed by the at least one processor, may cause the electronic device to perform scrolling of the merged page in a designated direction based on the first input, and to perform paging of another page in a designated direction based on the second input.

According to one and more embodiments, the instructions, when executed by the at least one processor, may cause the electronic device to display the at least one second content in a highlighted manner based on a specified effect while scrolling the merged page.

According to one and more embodiments, the specified effect may include effects of slowing down the movement speed of a page portion corresponding to the at least one second content, slowing down the movement speed based on margins on both sides of the page portion, edge highlighting, and/or haptic output.

According to one and more embodiments, the instructions, when executed by the at least one processor, may cause the electronic device to evaluate the defined condition, determine whether at least one second content having the defined condition is present based on pieces of content of the source pages, and mark, if at least one second content is present, at least one page corresponding to the at least one second content among the source pages.

According to one and more embodiments, the defined condition may include a criterion for determining key factors affecting the importance of the content.

According to one and more embodiments, the instructions, when executed by the at least one processor, may cause the electronic device to evaluate the defined condition based on a user's context, presence or absence of an update, the amount of information in the content, a notification trigger, and/or a user's preference.

According to one and more embodiments, the instructions, when executed by the at least one processor, may cause the electronic device to set a specified margin in the at least one marked page when merging the source pages.

According to one and more embodiments, the marking may include location information for identifying a page on which the at least one second content is located.

According to one and more embodiments, the instructions, when executed by the at least one processor, may cause the electronic device to identify a marked page while scrolling the merged page, and to adjust the scroll speed based on the marked page.

According to one and more embodiments, the instructions, when executed by the at least one processor, may cause the electronic device to generate the merged image by including a start page and an end page of the source pages in the page merge section.

According to one and more embodiments, the instructions, when executed by the at least one processor, may cause the electronic device to display the start page of the source pages when generating the merged image by including the start page and the end page of the source pages, display the start page portion of the merged image with a transition effect specified in response to a user input, scroll from the start page portion to the end page portion of the merged image, and display the end page of the source pages with a specified transition effect upon reaching the end page portion.

According to one and more embodiments, the instructions, when executed by the at least one processor, may cause the electronic device to generate the merged image based on a page between the start page and the end page of the source pages (e.g., in-between page, middle page, or en-route page).

According to one and more embodiments, the instructions, when executed by the at least one processor, may cause the electronic device to merge entire pages set in the electronic device in advance based on a defined condition.

According to one and more embodiments, the instructions, when executed by the at least one processor, may cause the electronic device to monitor the defined condition for content, merge entire pages to generate an image based on detecting the defined condition, and update the entire merged image by using the generated image.

According to one and more embodiments, the defined condition may include an update related to the content causing a change in data of the content, and/or a turn-on/turn-off trigger of the display.

Next, a detailed description will be given of the operation method of the electronic device (e.g., electronic device 101 or wearable electronic device 200 of FIGS. 1 to 6) (hereinafter, electronic device 101) according to one and more embodiments. The operations performed in the electronic device 101 according to one and more embodiments may be executed by the processor (e.g., processor 120 in FIG. 1 or FIG. 6) including various processing circuitry and/or executable program elements of the electronic device 101. According to one and more embodiments, the operations performed in the electronic device 101 may be stored as instructions in the memory (e.g., memory 130 in FIG. 1 or FIG. 6) and individually and/or collectively executed by the processor 120.

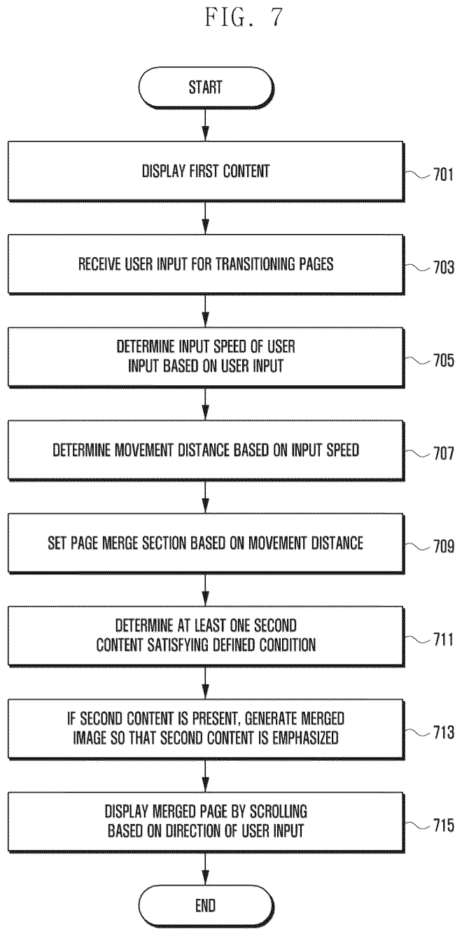

FIG. 7 is a flowchart illustrating an operation method of the electronic device according to one and more embodiments of the disclosure.

According to one and more embodiments, FIG. 7 may illustrate an example of a method for supporting transitioning between pages (or, tiles) based on user input in the electronic device 101 according to one and more embodiments.

The method for supporting transitioning between pages (or, tiles) based on user input in the electronic device 101 according to one and more embodiments of the disclosure may be performed, for example, according to the flowchart illustrated in FIG. 7. The flowchart illustrated in FIG. 7 is an example according to one and more embodiments of the operation of the electronic device 101, and at least some operations may be changed in order, performed in parallel, or performed as independent operations, or at least some other operations may be performed complementarily to at least some operations. According to one and more embodiments, operations 701 to 715 may be performed by at least one processor (e.g., processor 120 in FIG. 1 or FIG. 6) of the electronic device 101.

As illustrated in FIG. 7, the operation method performed by the electronic device 101 according to one and more embodiments may include an operation of displaying first content (operation 701), an operation of receiving a user input for transitioning pages (operation 703), an operation of determining the input speed of the user input based on the user input (operation 705), an operation of determining the movement distance based on the input speed (operation 707), an operation of setting a page merge section (or, source pages) based on the movement distance (operation 709), an operation of determining at least one second content satisfying a defined condition (operation 711), an operation of generating, if second content is present, a merged image so that the second content is emphasized (operation 713), and an operation of displaying the merged page by scrolling based on the direction of the user input (operation 715).

With reference to FIG. 7, at operation 701, the processor 120 of the electronic device 101 may display first content. According to one and more embodiments, the processor 120 may display first content (e.g., clock content), second content (e.g., notification content), or third content (e.g., application (or, widget) content) on the display. For example, the processor 120 may display the contents of a set page or a user-selected page.

At operation 703, the processor 120 may receive a user input for transitioning pages. According to one and more embodiments, the user input may include a touch gesture (or, touch-and-move gesture) (e.g., flick touch gesture, or swipe touch gesture) defined to transition (or, move) pages (or, tiles) on the display in a specified direction (e.g., leftward or rightward). According to one and more embodiments, the user input may include one or more of a first input (e.g., flick touch gesture) having a preset speed associated with transitioning over multiple pages (or, tiles), or a second input (e.g., swipe touch gesture) associated with transitioning on a page (tile) basis.

At operation 705, the processor 120 may determine the input speed of the user input (and/or the strength or speed value of a moving touch gesture) based on the user input. According to one and more embodiments, the processor 120 may determine the type of user input (e.g., first input or second input) based on the input speed. For example, a speed value of about 6500 (pixel/sec) may be set as a reference value for the input speed. If the speed value is greater than or equal to the reference value (e.g., input value in correspondence to a flick (or fast swipe)), it may be determined as a first input for moving as many pages corresponding to the speed value; and if the speed value is less than the reference value (e.g., about 6500 (pixel/sec)) (e.g., input value corresponding to a scroll (or slow swipe)), it may be determined as a second input for moving one page.

According to one and more embodiments, in relation to user input, value ranges (or, speed values) corresponding respectively to first speed, second speed, and N^{th} speed (e.g., N is a natural number greater than or equal to 3) may be defined. In one and more embodiments, scrolling over multiple pages according to the first input may be responsive to first speed, second speed, or N^{th} speed, respectively. In one and more embodiments, the first speed may be defined as a first range for the first input (e.g., greater than or equal to X speed and less than Y speed), the second speed may be defined as a second range for the first input (e.g., greater than or equal to Y speed and less than Z speed), and the third speed may be defined as a different range, such as an N^{th} range for the first input (e.g., greater than or equal to Z speed), where the range values may become larger in sequence.

In one and more embodiments, if the input speed of a user input is lower than the first speed (e.g., less than the first range value or less than X speed), the user input may be considered as a second input. According to one and more embodiments, if the input speed is determined to be greater than or equal to the first speed, the processor 120 may determine the user input as a first input and may identify the input speed corresponding to the first input. According to one and more embodiments, if the input speed is determined to be less than the first speed, the processor 120 may determine the user input as a second input.

According to one and more embodiments, the processor 120 may process scrolling over multiple pages in a specified direction based on a first input. According to one and more embodiments, the processor 120 may process paging of another page (e.g., next page or previous page) in a specified direction based on a second input. In one and more embodiments, FIG. 7 may be an example where the user input is a first input.

At operation 707, the processor 120 may determine the movement distance (or paging section) based on the input speed. According to one and more embodiments, the movement distance may be defined in correspondence to the input speed. According to one and more embodiments, a first movement distance may be mapped in correspondence to a first speed, a second movement distance may be mapped in correspondence to a second speed, and an N^{th} movement distance may be mapped in correspondence to an N^{th} speed. In one and more embodiments, the movement distance may correspond to the number of pages (or, tiles) to be merged including a movement start page, an in-between page (or, middle page, en-route page), and a movement end page (or, movement destination page) in correspondence to the input speed. In one and more embodiments, the first movement distance may be defined as merging 3 pages, the second movement distance as merging 5 pages, and the Nth movement distance as merging M pages.

At operation 709, the processor 120 may set a page merge section based on the movement distance. According to one and more embodiments, the processor 120 may determine the source pages (e.g., start page, in-between page, and end page) corresponding to the movement distance. According to one and more embodiments, the processor 120 may specify the source pages as the page merge section.

At operation 711, the processor 120 may determine at least one second content satisfying a defined condition. According to one and more embodiments, the processor 120 may determine at least one second content (e.g., at least one emphasized content) that satisfies a defined condition (e.g., condition requiring emphasis of content) among pieces of content of the source pages belonging to the page merge section. In one and more embodiments, the defined condition may include a condition related to the user's context, an update to the content (or information), the amount of information in the content, notification triggering, and/or user's preference. According to one and more embodiments, highlighting of content according to a defined condition will be described with reference to the drawings below.

At operation 713, if second content is present, the processor 120 may generate a merged image so that the second content is emphasized. According to one and more embodiments, the processor 120 may merge source pages based on the presence or absence of at least one second content. For example, if second content is present, the processor 120 may merge the source pages (e.g., generate a merged image) so that the second content is emphasized (e.g., emphasize the page where the second content is presented) in the source pages. For example, if second content is not present, the processor 120 may merge source pages (e.g., generate a merged image) without content highlighting (e.g., page emphasis). According to one and more embodiments, merging source pages (or, generating a merged image) is described with reference to the drawings below.

At operation 715, the processor 120 may display the merged page by scrolling based on the direction of the user input (e.g., leftward or rightward). According to one and more embodiments, the processor 120 may display at least one second content in an emphasized manner while scrolling the merged page (or, merged image) based on the direction of the user input. According to one and more embodiments, displaying at least one second content in an emphasized manner while scrolling the merged page will be described with reference to the drawings below.

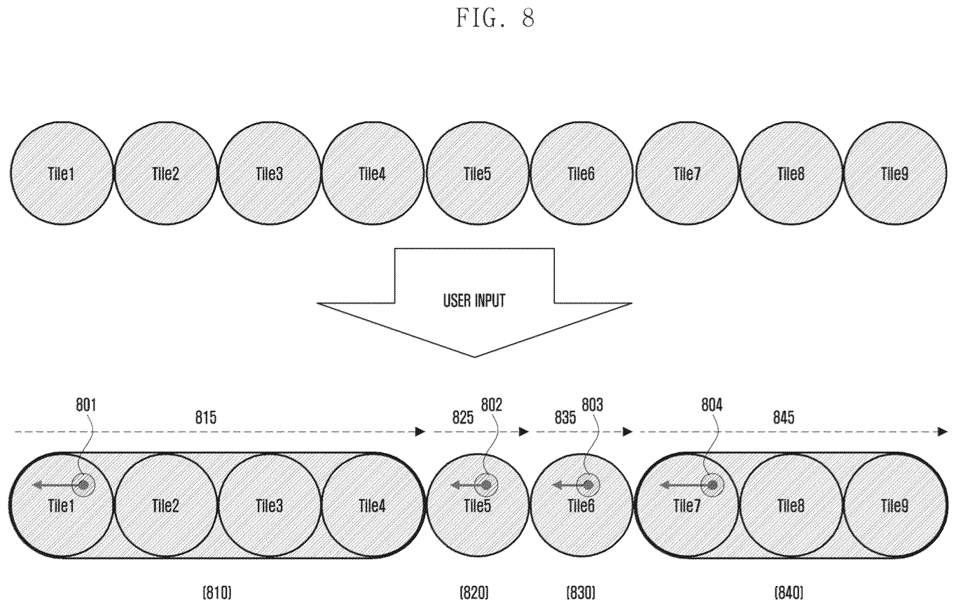

FIG. 8 is a diagram illustrating an example of transitioning pages based on user input in the electronic device according to one and more embodiments of the disclosure.

According to one and more embodiments, FIG. 8 may illustrate an example of determining a page merge section (or number of pages to be merged) based on the input speed (e.g., scroll speed) of a user input, and performing scrolling by merging pages belonging to the page merge section. According to one and more embodiments, the electronic device 101 may merge pages (tiles) to move by reflecting the movement distance according to the input speed (e.g., scroll speed) at which the user input is input, and perform scrolling to the corresponding position.

As shown in FIG. 8, the electronic device 101 may be configured with a plurality of tiles (or a plurality of pages). For example, the example of FIG. 8 may show an example of processing four user inputs in sequence (e.g., first touch gesture 801, second touch gesture 802, third touch gesture 803, fourth touch gesture 804) on nine tiles (or, nine pages). According to one and more embodiments, the electronic device 101 may provide page movement (or transitioning) (e.g., content transitioning) by merging and scrolling multiple pages according to a first input (e.g., flick touch gesture such as a fast touch gesture input in the left or right direction) among the user input types, and/or paging one page at a time according to a second input (e.g., swipe touch gesture such as a relatively slow touch gesture input in the left or right direction compared to the flick touch gesture) among the user input types. In the example of FIG. 8, nine tiles (or pages) are shown as an example without being limited thereto, and the electronic device 101 may provide more or fewer tiles (or pages) than nine.

According to one and more embodiments, indicia 810 and 840 may represent an example of merging multiple tiles (pages) to move at once into one and then scrolling to the corresponding position based on the input speed (or movement speed) of the user input. According to one and more embodiments, indicia 820 and 830 may represent an example of paging one tile (page) at a time for one user input.

According to one and more embodiments, as indicated by indicia 810, the user may enter a first touch gesture 801 in the left direction for rightward navigation (or movement) of tiles (e.g., left-to-right navigation) with respect to the tile currently displayed on the display (e.g., Tile 1). In one and more embodiments, the first touch gesture 801 may correspond to a first input (e.g., flick touch gesture) having a first input speed 815. According to one and more embodiments, the electronic device 101 may determine the first input speed 815 (e.g., scroll speed) of the first touch gesture 801 based on the first touch gesture 801. In one and more embodiments, the first input speed 815 is exemplified as a movement speed that can move up to four tiles.

According to one and more embodiments, the electronic device 101 may set four tiles (e.g., Tile 1, Tile 2, Tile 3, and Tile 4) corresponding to the first input speed 815 as a page merge section. For example, the electronic device 101 may merge Tile 1 to Tile 4. The electronic device 101 may display the merged page by scrolling based on the direction of the first touch gesture 801 (e.g., moving to the left). For example, the electronic device 101 may display Tile 1 to Tile 4 with one time scrolling in response to the first touch gesture 801.

According to one and more embodiments, as indicated by indicia 840, the user may enter a fourth touch gesture 804 in the leftward direction for rightward navigation (or movement) of tiles (e.g., left-to-right navigation) with respect to the tile currently displayed (e.g., Tile 7) on the display. In one and more embodiments, the fourth touch gesture 804 may correspond to a first input (e.g., flick touch gesture) having a fourth input speed 845 (e.g., input speed that is the same as the first input speed or a different input speed (e.g., input speed that is greater than or less than the first input speed)). According to one and more embodiments, the electronic device 101 may determine the fourth input speed 845 (e.g., scroll speed) of the fourth touch gesture 804 based on the fourth touch gesture 804. In one and more embodiments, the fourth input speed 845 is exemplified as a movement speed that can move up to three tiles. In the example of FIG. 8, three tiles are merged according to the fourth input speed, without being limited thereto. For example, assuming that the fourth input speed 845 is a movement speed that can move up to four tiles, since there are three tiles that may be merged in the right direction with respect to Tile 7, the tiles to be merged may include three tiles (e.g., Tile 7, Tile 8, and Tile 9).

According to one and more embodiments, the electronic device 101 may set three tiles (e.g., Tile 7, Tile 8, and Tile 9) corresponding to the fourth input speed 845 as a page merge section. For example, the electronic device 101 may merge Tile 7 to Tile 9. The electronic device 101 may display the merged page by scrolling based on the direction of the fourth touch gesture 804 (e.g., moving to the left). For example, the electronic device 101 may display Tile 7 to Tile 9 with one time scrolling in response to the fourth touch gesture 804.

As indicated by indicia 820 and 830, the user may enter a touch gesture (e.g., second touch gesture 802 or third touch gesture 803) in the leftward direction for rightward navigation (or movement) of tiles (e.g., left-to-right navigation) with respect to the tile currently displayed on the display (e.g., Tile 5 or Tile 6). In one and more embodiments, the second touch gesture 802 and the third touch gesture 803 may correspond to a second input (e.g., swipe touch gesture) having a speed less than the specified speed (e.g., input speed 825 or 835 that can move up to one tile). According to one and more embodiments, the electronic device 101 may perform displaying by moving one page at a time (e.g., paging to the next tile) for the second touch gesture 802 or the third touch gesture 803.

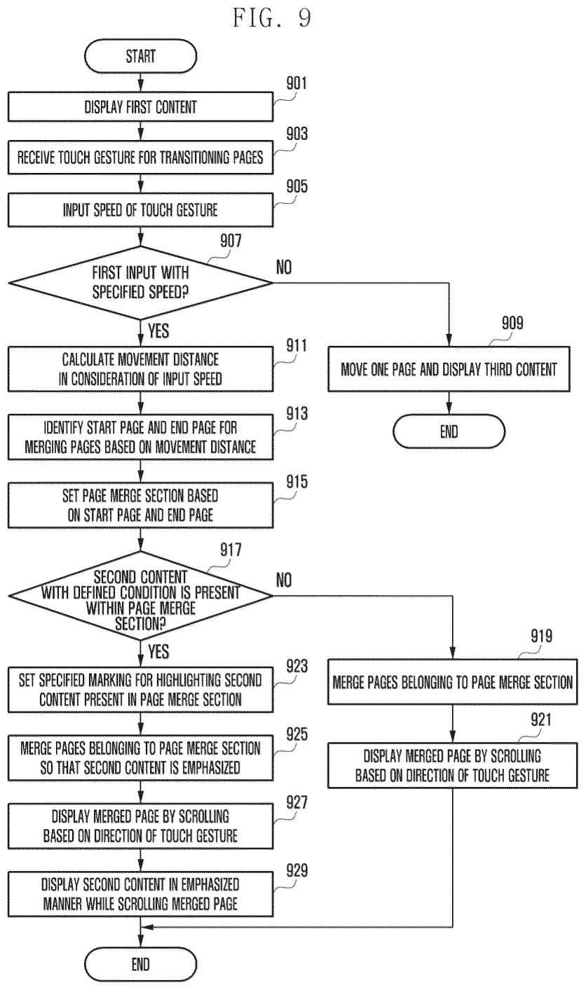

FIG. 9 is a flowchart illustrating an operation method of the electronic device according to one and more embodiments of the disclosure.

According to one and more embodiments, FIG. 9 may illustrate an example of a method for supporting transitioning between pages (or tiles) based on user input in the electronic device 101 according to one and more embodiments.

The method for supporting transitioning between pages (or, tiles) based on user input in the electronic device 101 according to one and more embodiments of the disclosure may be performed, for example, according to the flowchart illustrated in FIG. 9. The flowchart illustrated in FIG. 9 is an example according to one and more embodiments of the operation of the electronic device 101, and at least some operations may be changed in order, performed in parallel, or performed as independent operations, or at least some other operations may be performed complementarily to at least some operations. According to one and more embodiments, operations 901 to 929 may be performed by at least one processor (e.g., processor 120 in FIG. 1 or FIG. 6) of the electronic device 101.

According to one and more embodiments, the operations described in FIG. 9 may be performed heuristically, for example, in combination with the operations described in FIGS. 7 to 8, or heuristically performed in combination with at least some other operations while replacing at least some of the described operations, or heuristically performed as a detailed operation of at least some of the described operations.

As illustrated in FIG. 9, the operation method performed by the electronic device 101 according to one and more embodiments may include an operation of displaying first content (operation 901), an operation of receiving a touch gesture (or, user input) for transitioning pages (operation 903), an operation of determining the input speed of the touch gesture based on the touch gesture (operation 905), an operation of determining whether the touch gesture is a first input with a specified speed (operation 907), an operation of moving, if the touch gesture is a second input with a lower speed than the specified speed, one page and displaying third content (operation 909), an operation of calculating, if the touch gesture is a first input with a specified speed, the movement distance in consideration of the input speed (operation 911), an operation of determining a start page and an end page for merging pages based on the movement distance (operation 913), an operation of setting a page merge section based on the start page and the end page (operation 915), an operation of determining whether there is second content with a defined condition in the page merge section (operation 917), an operation of merging, if there is no second content, pages belonging to the page merge section without content emphasis (operation 919), an operation of displaying the merged page by scrolling based on the direction of the touch gesture (operation 921), an operation of setting, if there is second content, a specified marking for highlighting the second content in the page merge section (operation 923), an operation of merging pages belonging to the page merge section so that the second content is emphasized (operation 925), an operation of displaying the merged page by scrolling based on the direction of the touch gesture (operation 927), and an operation of displaying the second content in an emphasized manner while scrolling the merged page (operation 929).

With reference to FIG. 9, at operation 901, the processor 120 of the electronic device 101 may display first content. According to one and more embodiments, the processor 120 may display first content (e.g., clock content), second content (e.g., notification content), or third content (e.g., application (or, widget) content) on the display. For example, the processor 120 may display the contents of a preset page or a user-selected page.

At operation 903, the processor 120 may receive a touch gesture (or, user input) for transitioning pages. According to one and more embodiments, the touch gesture may include a touch-based input (e.g., flick touch gesture or swipe touch gesture) defined to transition (or move) pages (or, tiles) on the display in a specified direction (e.g., leftward or rightward). According to one and more embodiments, the touch gesture may include a first input (e.g., flick touch gesture) having a specified speed associated with transitioning over multiple pages (or, tiles), and a second input (e.g., swipe touch gesture) associated with transitioning on a page (tile) basis.

At operation 905, the processor 120 may determine the input speed of the touch gesture (and/or a strength of the moving touch gesture) based on the touch gesture.

At operation 907, the processor 120 may determine whether the touch gesture is a first input with a specified speed. According to one and more embodiments, the processor 120 may identify the type of the touch gesture (e.g., first input or second input) based on the input speed of the touch gesture. In one and more embodiments, scrolling over multiple pages according to the first input may respond to the speed greater than or equal to the specified speed (e.g., first speed, second speed, or N^{th} speed).

In one and more embodiments, if the input speed of the touch gesture is lower than the first speed, the touch gesture may be considered as a second input. According to one and more embodiments, if the input speed is determined to be greater than or equal to the specified speed, the processor 120 may determine the touch gesture as a first input and determine the input speed in correspondence to the first input. According to one and more embodiments, if the input speed is determined to be less than the specified speed, the processor 120 may determine the touch gesture as a second input.

According to one and more embodiments, the processor 120 may process scrolling over multiple pages in a specified direction based on the first input. According to one and more embodiments, the processor 120 may process paging of another page (e.g., next page or previous page) in a specified direction based on the second input.

If it is determined that the touch gesture is a second input with a speed less than the specified speed at operation 907 (e.g., “NO” at operation 907), at operation 909, the processor 120 may move one page (e.g., next page or previous page) based on the touch gesture and display third content of the corresponding page.

If it is determined that the touch gesture is a first input with a specified speed at operation 907 (e.g., “Yes” at operation 907), at operation 911, the processor 120 may calculate the movement distance (or, paging section) in consideration of the input speed. According to one and more embodiments, a movement distance corresponding to each input speed may be defined. According to one and more embodiments, a first movement distance may be mapped to a first speed, a second movement distance may be mapped to a second speed, and an N^{th} movement distance may be mapped to an N^{th} speed. In one and more embodiments, the movement distance may correspond to the number of pages (or tiles) to be merged including a movement start page, an in-between page, and a movement end page (or, movement destination page) in correspondence to the input speed. In one and more embodiments, the larger the movement distance, the more pages can be merged.

At operation 913, the processor 120 may determine the start page and the end page for page merging based on the movement distance. According to one and more embodiments, the processor 120 may determine source pages (e.g., start page, in-between page, and end page) corresponding to the movement distance.

At operation 915, the processor 120 may set a page merge section based on the start page and the end page. According to one and more embodiments, the processor 120 may set a page merge section based on source pages (e.g., start page, in-between page, and end page).

At operation 917, the processor 120 may determine whether second content with a defined condition is present in the page merge section. According to one and more embodiments, the processor 120 may determine at least one second content (e.g., at least one emphasized content) that satisfies a defined condition (e.g., condition requiring emphasis of content) among pieces of content of the source pages belonging to the page merge section. In one and more embodiments, the defined condition may include a condition related to the user's context, an update to the content (or information), the amount of information in the content, notification triggering, and/or user's preference. According to one and more embodiments, highlighting of content according to a defined condition will be described with reference to the drawings below.

If second content with a defined condition is not present at operation 917 (e.g., “No” at operation 917), at operation 919, the processor 120 may merge pages belonging to the page merge section without highlighted content. According to one and more embodiments, if second content is not present, the processor 120 may merge the source pages (e.g., generate a merged image) without highlighted content (e.g., highlighted page).

At operation 921, the processor 120 may display the merged page by scrolling based on the direction of the touch gesture. According to one and more embodiments, the processor 120 may scroll up to the corresponding destination position (e.g., end page of the pages being merged) in response to the touch gesture.

If second content with a defined condition is present at operation 917 (e.g., “Yes” at operation 917), at operation 923, the processor 120 may set a specified marking (or, indicator) for highlighting the second content in the page merge section. According to one and more embodiments, based on at least one second content or a page (or tile) of the second content within the page merge section, the processor 120 may set a specified marking (e.g., controlling the movement speed, applying margins, applying highlighting, and/or applying haptics) for highlighting the second content. According to one and more embodiments, the marking (or indicator) may include location information, for example, for identifying the location of the second content (or, identifying the page location of the second content). According to one and more embodiments, setting a specified marking for emphasizing at least one second content will be described with reference to the following drawings.

At operation 925, the processor 120 may merge pages belonging to the page merge section so that the second content is emphasized. According to one and more embodiments, the processor 120 may merge source pages based on the presence or absence of at least one second content. For example, if second content is present, the processor 120 may merge the source pages (e.g., generate a merged image) so that the second content is emphasized (e.g., emphasizes the page where the second content is presented) in the source pages. According to one and more embodiments, merging source pages (or, generating a merged image) will be described with reference to the drawings below.

At operation 927, the processor 120 may display the merged page by scrolling based on the direction of the touch gesture (e.g., leftward or rightward). According to one and more embodiments, the processor 120 may process scrolling based on the merged page. According to one and more embodiments, the processor 120 may perform scrolling up to the corresponding destination position (e.g., end page of pages being merged) in response to the touch gesture.

At operation 929, the processor 120 may display the second content in an emphasized manner while scrolling the merged page. According to one and more embodiments, the processor 120 may display at least one second content in an emphasized manner while scrolling the merged page (or, merged image) based on the direction of the touch gesture. According to one and more embodiments, when a scroll stop input is received while scrolling, the processor 120 may stop scrolling and display content (e.g., second content) of the page at the stopped position. According to one and more embodiments, displaying at least one second content in an emphasized manner while scrolling will be described with reference to the drawings below.

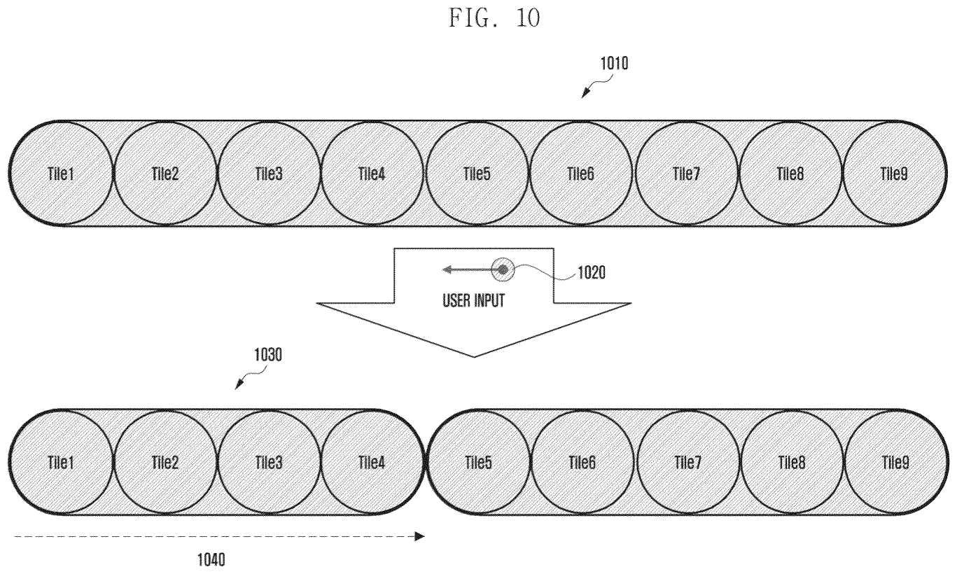

FIG. 10 is a diagram illustrating an example of transitioning pages based on user input in the electronic device according to one and more embodiments of the disclosure.

According to one and more embodiments, FIG. 10 may illustrate an example of determining a page merge section (or, the number of pages to be merged) based on the input speed (e.g., scroll speed) of a user input (or, touch gesture) 1020, separating pages 1030 of the page merge section from a pre-merged entire merged page (or, entire merged image) 1010, and scrolling the pages 1030 of the separated page merge section (e.g., separated pages). According to one and more embodiments, the electronic device 101 may separate pages (tiles) to move from the entire merged page 1010 by reflecting the movement distance 1040 according to the input speed (e.g., scroll speed) at which the user input 1020 is input, and process scrolling up to the position (e.g., destination page) corresponding to the user input 1020 based on the separated pages 1030.

As illustrated in FIG. 10, the electronic device 101 may be configured with a plurality of tiles (or, a plurality of pages). For example, there are 9 tiles (or 9 pages) in the example of FIG. 10. According to one and more embodiments, the electronic device 101 may provide page movement (or transitioning) (e.g., content transitioning) by separating multiple pages from a pre-merged entire merged page 1010 and scrolling them according to a first input (e.g., flick touch gesture) among the user input types, and/or by paging one page at a time according to a second input (e.g., swipe touch gesture) among the user input types. In the example of FIG. 10, nine tiles (or pages) are shown, but without being limited thereto, the electronic device 101 may be provided with more or fewer tiles (or pages) than nine.

According to one and more embodiments, the electronic device 101 may monitor a defined condition for content. In one and more embodiments, the defined condition may include an update related to content, such as a change in data (or information) of the content (e.g., change in weather, reception of external notification, generation of internal notification), and/or a trigger, such as a turn-on/turn-off of the display. According to one and more embodiments, the electronic device 101 may monitor a defined condition and merge entire tiles (or pages) based on detecting the defined condition. For example, the electronic device 101 may update the entire merged page 1010 by merging all tiles at the time of content data update (e.g., weather change, notification receipt), display turn-on, and/or display turn-off.

According to one and more embodiments, the electronic device 101 may determine the movement distance (or, paging section) 1040 based on the input speed of the user input 1020. According to one and more embodiments, the electronic device 101 may identify source pages (e.g., Tile 1, Tile 2, Tile 3, and Tile 4) corresponding to the movement distance 1040. According to one and more embodiments, the electronic device 101 may separate the source pages 1030 from the entire merged page 1010. According to one and more embodiments, the electronic device 101 may process scrolling based on the separated pages 1030. According to one and more embodiments, the electronic device 101 may scroll up to the corresponding destination position (e.g., end page of separated pages (e.g., Tile 4)) in response to the user input 1020.

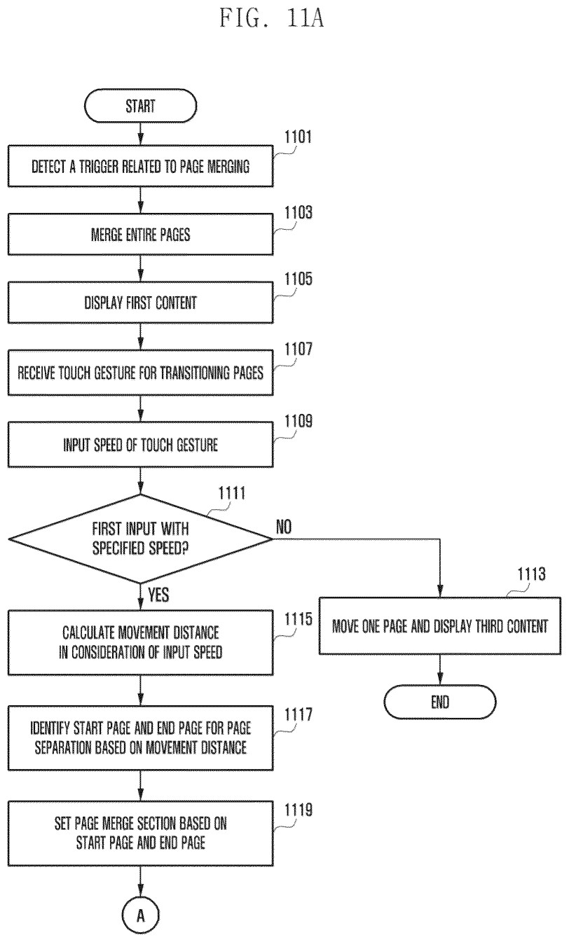

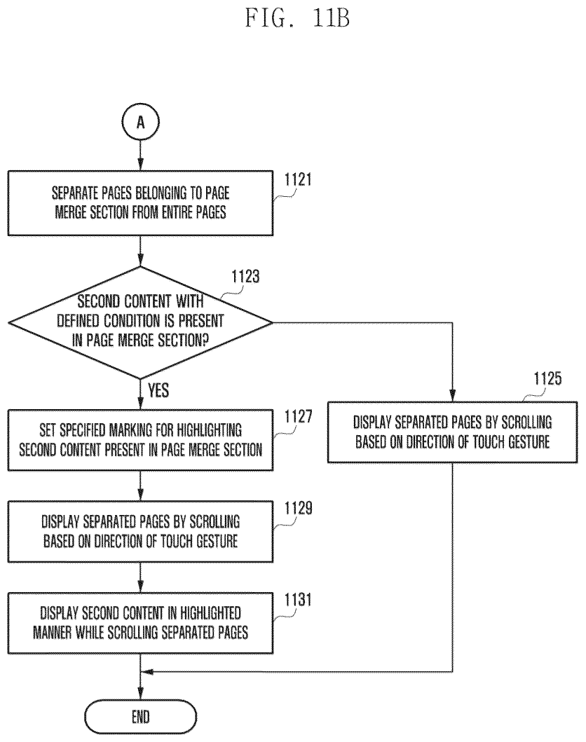

FIGS. 11A and 11B are flowcharts illustrating an operation method of the electronic device according to one and more embodiments of the disclosure.

According to one and more embodiments, FIGS. 11A and 11B may illustrate an example of a method for supporting transitioning between pages (or, tiles) based on user input in the electronic device 101 according to one and more embodiments.

The method for supporting transitioning between pages (or, tiles) based on user input in the electronic device 101 according to one and more embodiments of the disclosure may be performed, for example, according to the flowchart illustrated in FIGS. 11A and 11B. The flowchart illustrated in FIGS. 11A and 11B is an example according to one and more embodiments of the operation of the electronic device 101, and at least some operations may be changed in order, performed in parallel, or performed as independent operations, or at least some other operations may be performed complementarily to at least some operations. According to one and more embodiments, operations 1101 to 1131 may be performed by at least one processor (e.g., processor 120 in FIG. 1 or FIG. 6) of the electronic device 101.

According to one and more embodiments, the operations described in FIGS. 11A and 11B may be performed heuristically, for example, in combination with the operations described in FIGS. 7 to 10, or heuristically performed in combination with at least some other operations while replacing at least some of the described operations, or heuristically performed as a detailed operation of at least some of the described operations.

As shown in FIG. 11A and FIG. 11B, the operation method performed by the electronic device 101 according to one and more embodiments may include an operation of detecting a trigger related to page merging (operation 1101), an operation of merging entire pages (operation 1103), an operation of displaying first content (operation 1105), an operation of receiving a touch gesture (or, user input) for transitioning pages (operation 1107), an operation of determining the input speed of the touch gesture based on the touch gesture (operation 1109), an operation of determining whether the touch gesture is a first input with a specified speed (operation 1111), an operation of moving, if the touch gesture is a second input with a lower speed than the specified speed, one page and displaying third content (operation 1113), an operation of calculating, if the touch gesture is a first input with a specified speed, the movement distance in consideration of the input speed (operation 1115), an operation of identifying a start page and an end page for page separation based on the movement distance (operation 1117), an operation of setting a page merge section based on the start page and the end page (operation 1119), an operation of separating pages belonging to the page merge section from the entire pages (operation 1121), an operation of determining whether there is second content with a defined condition in the page merge section (operation 1123), an operation of displaying, if there is no second content, the separated pages by scrolling based on the direction of the touch gesture without content highlighting (operation 1125), an operation of setting, if there is second content, a specified marking for highlighting the second content in the page merge section (operation 1127), an operation of displaying the separated pages by scrolling based on the direction of the touch gesture (operation 1129), and an operation of displaying the second content in a highlighted manner while scrolling the separated pages (operation 1131).

With reference to FIGS. 11A and 11B, at operation 1101, the processor 120 of the electronic device 101 may detect a trigger related to page merging. According to one and more embodiments, the processor 120 may monitor a defined condition for content. In one and more embodiments, the defined condition may include an update related to content, such as a change in data (or information) of the content (e.g., weather change, reception of an external notification, generation of an internal notification), and/or a trigger, such as turning on/off of the display.

At operation 1103, the processor 120 may merge the entire pages. According to one and more embodiments, the processor 120 may merge entire pages (or tiles) based on detecting a trigger (e.g., defined condition). For example, the electronic device 101 may update the entire pages (or, entire merged page) by merging all tiles at the time of data update of content (e.g., weather change, notification receipt), display turn-on, and/or display turn-off.

At operation 1105, the processor 120 may display first content. According to one and more embodiments, the processor 120 may display first content (e.g., clock content), second content (e.g., notification content), or third content (e.g., application (or, widget) content) on the display. For example, the processor 120 may display the contents of a set page or a user-selected page.

At operation 1107, the processor 120 may receive a touch gesture (or, user input) for transitioning pages. According to one and more embodiments, the touch gesture may include a touch-based input (e.g., flick touch gesture or swipe touch gesture) defined to transition (or, move) pages (or, tiles) on the display in a specified direction (e.g., leftward or rightward). According to one and more embodiments, the touch gesture may include a first input (e.g., flick touch gesture) having a specified speed associated with transitioning over multiple pages (or tiles), and a second input (e.g., swipe touch gesture) associated with transitioning on a page (or tile) basis.

At operation 1109, the processor 120 may determine the input speed of the touch gesture (and/or the strength of the moving touch gesture) based on the touch gesture.

At operation 1111, the processor 120 may determine whether the touch gesture is a first input with a specified speed. According to one and more embodiments, the processor 120 may identify the type of the touch gesture (e.g., first input or second input) based on the input speed of the touch gesture. In one and more embodiments, scrolling over multiple pages according to the first input may respond to the speed greater than or equal to the specified speed (e.g., first speed, second speed, or N^{th} speed).

In one and more embodiments, if the input speed of the touch gesture is lower than the first speed, the touch gesture may be considered as a second input. According to one and more embodiments, if the input speed is determined to be greater than or equal to the specified speed, the processor 120 may determine the touch gesture as a first input and determine the input speed in correspondence to the first input. According to one and more embodiments, if the input speed is determined to be less than the specified speed, the processor 120 may determine the touch gesture as a second input.

According to one and more embodiments, the processor 120 may process scrolling over multiple pages in a specified direction based on the first input. According to one and more embodiments, the processor 120 may process paging of another page (e.g., next page or previous page) in a specified direction based on the second input.

If the touch gesture is a second input with a speed less than the specified speed at operation 1111 (e.g., “NO” at operation 1111), at operation 1113, the processor 120 may move one page (e.g., next page or previous page) and display third content of the corresponding page.

If the touch gesture is a first input with a specified speed at operation 1111 (e.g., “Yes” at operation 1111), at operation 1115, the processor 120 may calculate the movement distance (or, paging section) in consideration of the input speed. According to one and more embodiments, a movement distance corresponding to each input speed may be defined. According to one and more embodiments, a first movement distance may be mapped to a first speed, a second movement distance may be mapped to a second speed, and an N^{th} movement distance may be mapped to an N^{th} speed. In one and more embodiments, the movement distance may correspond to the number of pages (or tiles) to be merged (or, to be separated) including a movement start page, an in-between page, and a movement end page (or, movement destination page) in correspondence to the input speed. In one and more embodiments, the larger the movement distance, the more pages can be merged (or, separated).

At operation 1117, the processor 120 may determine the start page and the end page for page separation based on the movement distance. According to one and more embodiments, the processor 120 may determine source pages (e.g., start page, in-between page, and end page) corresponding to the movement distance.

At operation 1119, the processor 120 may set a page merge section based on the start page and the end page. According to one and more embodiments, the processor 120 may set a page merge section based on source pages (e.g., start page, in-between page, and end page).

At operation 1121, the processor 120 may separate pages belonging to the page merge section from the entire pages. According to one and more embodiments, the processor 120 may separate the source pages from the entire pages (or, entire merged page).

At operation 1123, the processor 120 may determine whether second content with a defined condition is present in the page merge section. According to one and more embodiments, the processor 120 may determine at least one second content (e.g., at least one emphasized content) that satisfies a defined condition (e.g., condition requiring emphasis of content) among pieces of content of the source pages belonging to the page merge section. In one and more embodiments, the defined condition may include a condition related to the user's context, an update to the content (or information), the amount of information in the content, notification triggering, and/or user's preference. According to one and more embodiments, highlighting of content according to a defined condition will be described with reference to the drawings below.

If second content is not present at operation 1123 (e.g., “No” at operation 1123), at operation 1125, the processor 120 may display the separated pages without content highlighting by scrolling based on the direction of the touch gesture. According to one and more embodiments, the processor 120 may scroll up to the corresponding destination position (e.g., end page of the merged page) in response to the touch gesture.

If second content with a defined condition is present at operation 1123 (e.g., “Yes” at operation 1123), at operation 1127, the processor 120 may set a specified marking (or, indicator) for highlighting the second content in the page merge section. According to one and more embodiments, based on at least one second content or a page (or tile) of the second content within the page merge section, the processor 120 may set a specified marking (e.g., controlling the movement speed, applying margins, applying highlighting, and/or applying haptics) for highlighting the second content. According to one and more embodiments, the marking (or indicator) may include location information, for example, for identifying the location of the second content (or, identifying the page location of the second content). According to one and more embodiments, setting a specified marking for emphasizing at least one second content will be described with reference to the following drawings.

At operation 1129, the processor 120 may display the separated pages by scrolling based on the direction of the touch gesture. According to one and more embodiments, the processor 120 may process scrolling based on the separated pages. According to one and more embodiments, the processor 120 may scroll up to the corresponding destination position (e.g., end page of the separated pages) in response to the touch gesture. According to one and more embodiments, when a scroll stop input is received while scrolling, the processor 120 may stop scrolling and display content (e.g., second content) of the page at the stopped position.

At operation 1131, the processor 120 may display the second content in an emphasized manner while scrolling the separated pages. According to one and more embodiments, the processor 120 may display at least one second content in an emphasized manner while scrolling the separated pages based on the direction of the touch gesture. According to one and more embodiments, when a scroll stop input is received while scrolling, the processor 120 may stop scrolling and display content (e.g., second content) of the page at the stopped position. According to one and more embodiments, displaying at least one second content in an emphasized manner while scrolling will be described with reference to the drawings below.

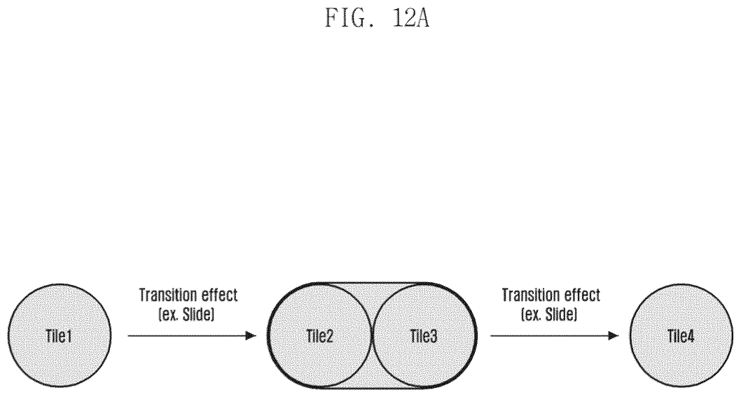

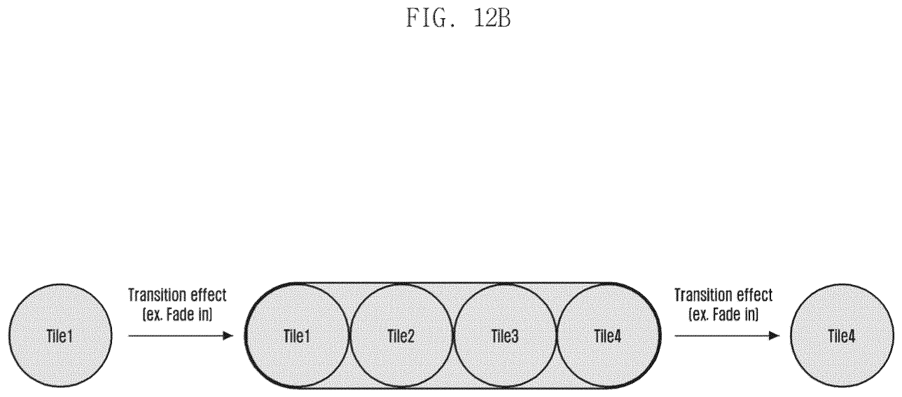

FIG. 12A is a diagram illustrating an example of page merging in the electronic device according to one and more embodiments of the disclosure.

According to one and more embodiments, FIG. 12A may illustrate an example of determining a page merge section (or number of pages to be merged) based on the input speed (e.g., scroll speed) of a user input and merging pages belonging to the page merge section. According to one and more embodiments, FIG. 12A may illustrate an example of a method for merging source pages (e.g., start page, in-between page, end page) of the page merge section by excluding the start page and the end page.

With reference to FIG. 12A, when merging source pages, the electronic device 101 may perform page merging based on the in-between pages (e.g., Tile 2 and Tile 3) between the start page (e.g., Tile 1) and the end page (e.g., Tile 4) of the source pages by leaving out (or, excluding) the start page and/or the end page. According to one and more embodiments, FIG. 12A may illustrate an example of excluding the start page and the end page from the merged page (e.g., merged image).

According to one and more embodiments, in the case of merging by excluding the start page and the end page as shown in FIG. 12A, the electronic device 101 may display the start page (e.g., Tile 1) of the source pages, and display the start page portion (e.g., Tile 2 portion) of the merged page (e.g., merged image) with a transition effect (e.g., slide) specified in response to a user input. According to one and more embodiments, the electronic device 101 may scroll from the start page portion (e.g., Tile 2 portion) up to the end page portion (e.g., Tile 3 portion) of the merged page (e.g., merged image). According to one and more embodiments, the electronic device 101 may display the end page (e.g., Tile 4) of the source pages with a specified transition effect (e.g., slide) when reaching the end page portion of the merged page (e.g., merged image).

FIG. 12B is a diagram illustrating an example of page merging in the electronic device according to one and more embodiments of the disclosure.

According to one and more embodiments, FIG. 12B may illustrate an example of determining a page merge section (or, number of pages to be merged) based on the input speed (e.g., scroll speed) of a user input and merging pages belonging to the page merge section. According to one and more embodiments, FIG. 12B may illustrate an example of merging by including a start page and an end page of the source pages belonging to the page merge section.

With reference to FIG. 12B, when merging source pages, the electronic device 101 may merge all pages including the start page (e.g., Tile 1), in-between middle pages (e.g., Tile 2 and Tile 3), and the end page (e.g., Tile 4) of the source pages.

According to one and more embodiments, in the case of merging by including the start page and the end page as shown in FIG. 12B, the electronic device 101 may display the start page (e.g., Tile 1) of the source pages, and display the start page portion (e.g., Tile 1 portion) of the merged page (e.g., merged image) with a transition effect (e.g., fade-in) specified in response to a user input. According to one and more embodiments, the electronic device 101 may scroll from the start page portion up to the end page portion (e.g., Tile 4 portion) of the merged page (e.g., merged image). According to one and more embodiments, the electronic device 101 may display the end page (e.g., Tile 4) of the source pages with a specified transition effect (e.g., fade-in) when reaching the end page portion of the merged page (e.g., merged image).

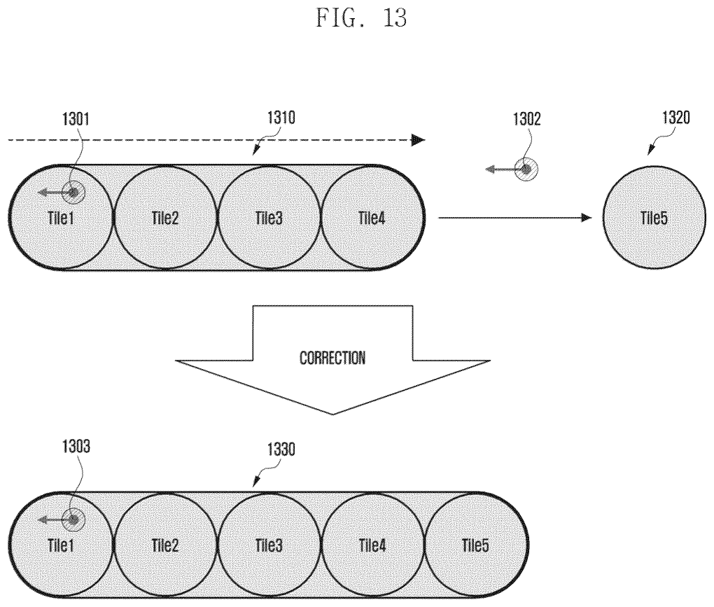

FIG. 13 is a diagram illustrating an example of page merging in the electronic device according to one and more embodiments of the disclosure.

According to one and more embodiments, FIG. 13 illustrates an example in which, when a pattern is found of performing scrolling over a movement distance of a merged page 1310 (e.g., Tile 1 to Tile 4) based on the input speed of a first user input 1301 (e.g., flick touch gesture), and then, within a specified time (e.g., 1 second, 2 seconds, or 3 seconds), moving to another page 1320 (e.g., next page (e.g., Tile 5) or previous page (e.g., Tile 3)), this pattern is learned, and the next user input is corrected (e.g., a correction value is reflected to the user input).

With reference to FIG. 13, the user may enter a first user input 1301 (e.g., flick touch gesture) to scroll a first merged page 1310 corresponding to the input speed of the first user input 1301, and while the end page (e.g., Tile 4) of the first merged page 1310 is displayed, enter a second user input 1302 (e.g., swipe touch gesture) within a specified time to move to the next page 1320 (e.g., Tile 5) of the first merged page 1310.

According to one and more embodiments, when detecting a user's pattern of moving by a movement distance according to the merged page 1310 and then moving to the next page 1320 within a specified time, the electronic device 101 may learn this user's pattern. According to one and more embodiments, based on the learning result, the electronic device 101 may apply a correction value for the learning result to the subsequent user input of the same input speed to thereby expand the scroll range. For example, when the electronic device 101 receives a third user input 1303 (e.g., flick touch gesture) at the same input speed as the first user input 1301, it may scroll a second merged page 1330 in which the next page 1320 (e.g., Tile 5) is additionally merged to the first merged page 1310 corresponding to the input speed, and display the end page (e.g., Tile 5) of the second merged page 1330.

According to one and more embodiments, the electronic device 101 may reduce the scroll range in a manner corresponding to expanding the scroll range as shown by the example of FIG. 13. According to one and more embodiments, when detecting a user's pattern of moving by a movement distance according to the merged page 1310 and then moving to the previous page (e.g., Tile 3) within a specified time, the electronic device 101 may learn this user's pattern. According to one and more embodiments, based on the learning result, the electronic device 101 may apply a correction value for the learning result to the subsequent user input of the same input speed to thereby reduce the scroll range. For example, when the electronic device 101 receives a user input (e.g., flick touch gesture) at the same input speed as the first user input 1301, it may scroll a merged page (e.g., merged image including Tile 1 to Tile 3) obtained by excluding the end page (e.g., Tile 4) from the first merged page 1310 corresponding to the input speed, and display the end page (e.g., Tile 3) of the merged page.

According to one and more embodiments, the electronic device 101 may correct the merged page (or, merged image) determined according to the input speed of a user input on the basis of the user pattern learned after moving by the movement distance corresponding to the merged page. For example, later, based on the learning result, the electronic device 101 may apply a correction value for the learning result to a user input of the same input speed to expand or reduce the scroll range. According to one and more embodiments, the range of pages added (or extended) to the existing merged page according to the input speed may be set in consideration of the number of user inputs (e.g., swipe touch gesture) entered within a specified time after moving by the movement distance corresponding to the merged page.

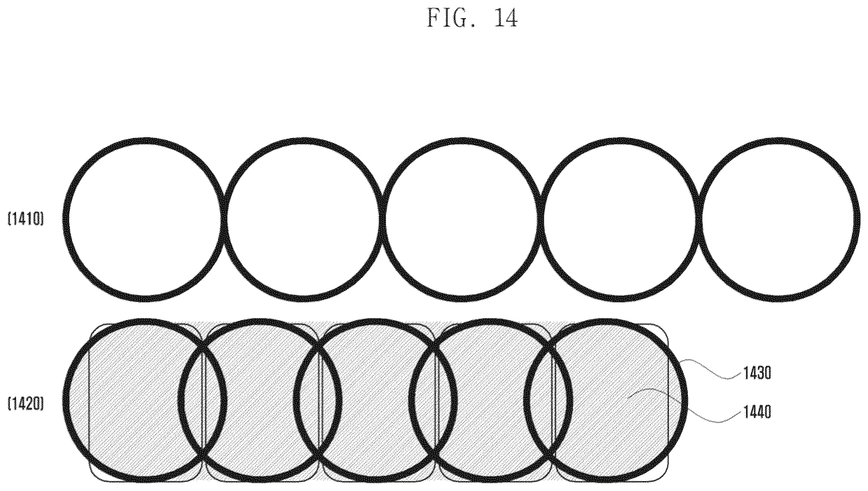

FIG. 14 is a diagram illustrating an example of page merging in the electronic device according to one and more embodiments of the disclosure.

According to one and more embodiments, the electronic device 101 (e.g., wearable electronic device 200) may have a shape corresponding to a circular shape, and the electronic device 101 may provide a circular screen. According to one and more embodiments, the electronic device 101 may merge pages (or, tiles) in a way optimized for the circular screen.

With reference to FIG. 14, indicia 1410 may represent an example in which each page before merging is presented in a circular form according to the circular screen. Indicia 1420 may represent an example in which pages are merged and presented as a single page (e.g., merged page) to fit the circular screen.

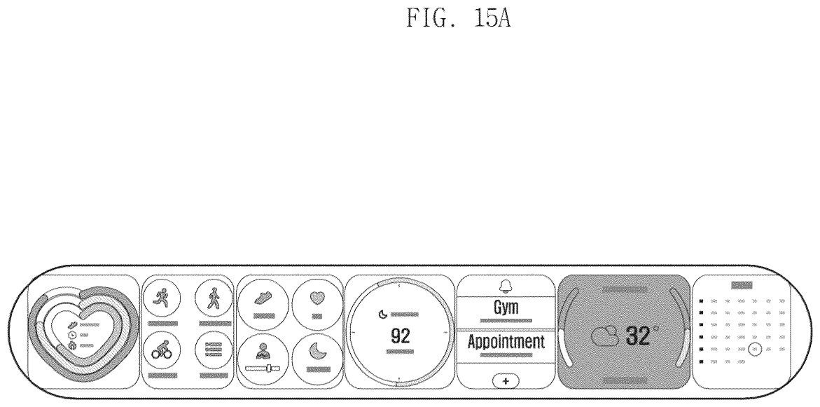

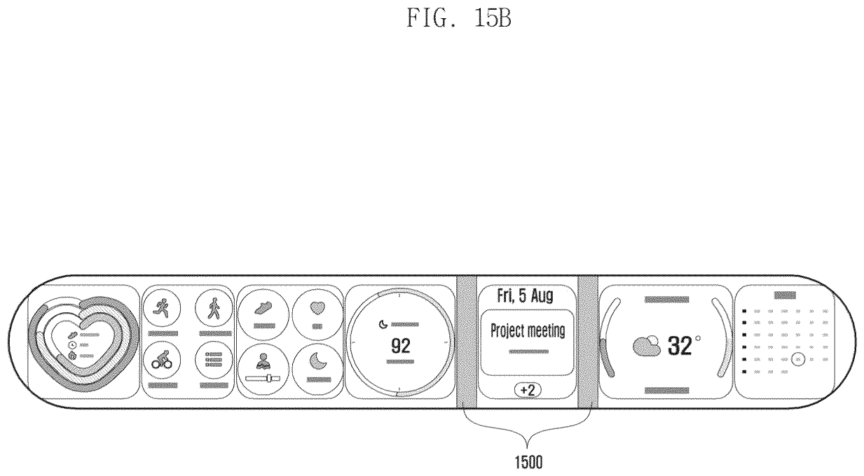

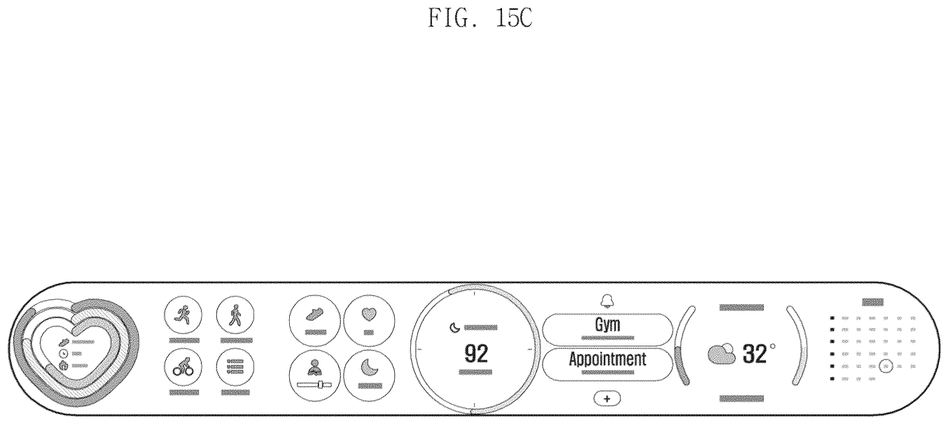

According to one and more embodiments, as indicated by indicia 1420, the electronic device 101 may merge pages in an optimized manner for the circular screen based on the existing page regions 1430 in a circular form before merging. For example, the pages may be merged based on merged page regions 1440 in the shape of a rounded rectangle by overlapping both sides of the existing page regions 1430 (e.g., both sides of illustrated circles), thereby minimizing empty space (e.g., background space). In one and more embodiments, the crop criteria of the round rectangular shape 1440 may be applied to, for example, the outermost portion of the region where the content provided in each page is present. According to one and more embodiments, examples of merging pages are shown in FIGS. 15A, 15B and 15C.

FIGS. 15A, 15B and 15C are diagrams illustrating various examples of page merging in the electronic device according to one and more embodiments of the disclosure.

According to one and more embodiments, FIG. 15A may illustrate an example of page merging. For example, in FIG. 15A, based on the circular shape of the electronic device 101, existing page regions 1430 may be overlapped at least partially to the left and right, and rounded square-shaped merged page regions (e.g., merged page regions 1440 in FIG. 14) may be set with respect to the points (or intersections) where the existing page regions (e.g., existing page regions 1430 in FIG. 14) intersect. In one and more embodiments, the content of pages being merged may be positioned inside the merged page region 1440. In one and more embodiments, as illustrated in FIG. 15A, the background portion (e.g., background portion on both sides of the content) may be removed from the merged page regions, and the spacing between merged page regions may be adjusted. For example, when merging, the margin (e.g., outside margin) between merged page regions may be removed, so that the merged pages can be arranged adjacent to each other.

According to one and more embodiments, FIG. 15B may illustrate an example of applying a specified emphasis (e.g., applying margins) to the highlighted content (or the page of content) when merging pages. As illustrated in FIG. 15B, when merging pages, specified margins 1500 (e.g., outside margin) may be applied to both sides of the merged page region for the highlighted content so as to merge pages (e.g., generate a merged image) in a way that the corresponding content is emphasized.

According to one and more embodiments, when merging pages, the electronic device 101 may merge pages in a state where the height and/or width of the pieces of content to be merged are reduced. According to one and more embodiments, if a specific page needs to be emphasized among the pages to be merged, the electronic device 101 may control the size so that the corresponding page is emphasized among the merged pieces of content by maintaining the existing height and/or width.

According to one and more embodiments, while scrolling the merged page, at a portion of the page (e.g., focus page) that is highlighted by applying the margins 1500, the electronic device 101 may provide an effect of reducing the scroll speed due to the margins 1500 on both sides of the merged page region, which allows the user to recognize the corresponding page. In one and more embodiments, the effect of scrolling speed reduction may vary based on the margins 1500. For example, if merging is performed with enlarged margins 1500, the effect of the time it takes for the corresponding page part to enter the display and disappear from the display may increase (e.g., speed reduction effect).

However, the disclosure is not limited thereto, and the electronic device 101 may substantially control the scroll speed (e.g., control reduction) in the highlighted page portion, thereby allowing the user to recognize the corresponding page.

According to one and more embodiments, FIG. 15C is provided for comparison with the merging method of the disclosure as illustrated in FIGS. 15A and 15B. For example, simply merged pages may be unintuitive and awkward on the circular screen due to the margins each page has (e.g., outside margins), and scrolling may be delayed due to the margins between pages.

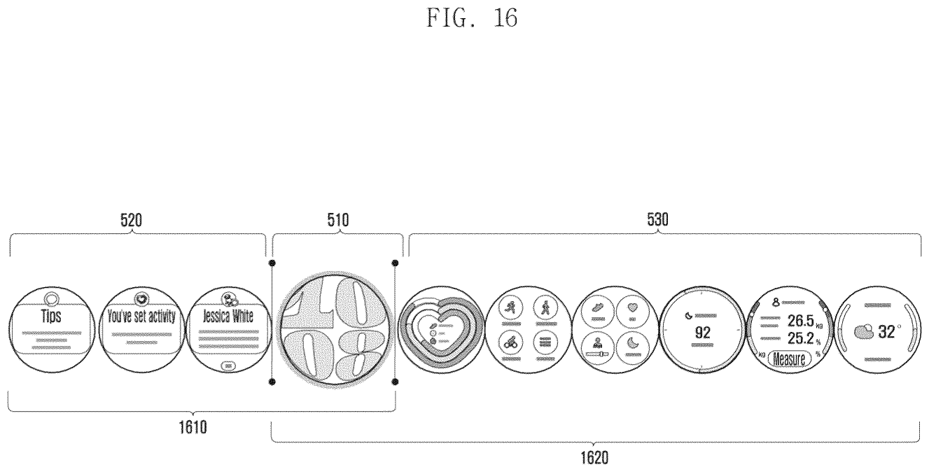

FIG. 16 is a diagram illustrating an example of transitioning pages in the electronic device according to one and more embodiments of the disclosure.

According to one and more embodiments, FIG. 16 may illustrate an example of a screen configuration provided through the display of the electronic device 101 (e.g., wearable electronic device 200 of FIGS. 2 to 4).

As shown in FIG. 16, the screen configuration of the electronic device 101 may be a screen structure divided into a first category (or section) 510 for watch content, a second category 520 for notification content, and a third category 530 for application (or widget) content, as described in the description with reference to FIG. 5.

According to one and more embodiments, the first category 510 may provide a screen related to watch content (e.g., watch screen, watch face, or home screen). In one and more embodiments, the first category 510 may be defined as a single page (or tile) for watch content.

According to one and more embodiments, the second category 520 may provide a screen related to notification content (e.g., notification screen). In one and more embodiments, the second category 520 may be defined as at least one page (or tile) corresponding to notification content received from the outside (e.g., external device) and/or generated internally in the electronic device 101.

According to one and more embodiments, the third category 530 may provide a screen related to application (or widget) content (e.g., content screen). In one and more embodiments, the third category 530 may be defined as at least one page (or tile) corresponding to the settings of the electronic device 101. For example, the third category 530 may include pages (tiles) corresponding respectively to applications (or widgets) configured on the electronic device 101, and content screens corresponding respectively to the applications (or widgets) may be provided on a page basis.

As illustrated in FIG. 16, the electronic device 101 may include a structure of second category 520 (e.g., notification content section)—first category 510 (e.g., watch face section)—third category 530 (e.g., content section). According to one and more embodiments, all screens of the first category 510, the second category 520, and the third category 530 may be divided into pages (or tiles), and may be moved (or paged) on a page basis (e.g., moved one page at a time) and/or moved (or scrolled) on the basis of a merged page (or, grouped pages, bundled pages, multiple pages) in response to a user input (e.g., flick or swipe).

According to one and more embodiments, when transitioning pages of a merged page (or merged image), the electronic device 101 can control the scroll speed to stop between categories. For example, the electronic device 101 may control the speed between categories (e.g., stop control) to allow the user to recognize the distinction between categories.

According to one and more embodiments, as indicated by indicia 1610, the electronic device 101 may perform scrolling or paging according to the input speed of a user input within the first category 510 and the second category 520. According to one and more embodiments, as indicated by indicia 1620, the electronic device 101 may perform scrolling or paging according to the input speed of a user input within the first category 510 and the third category 530. According to one and more embodiments, when generating a merged page (or, merged image), the electronic device 101 may generate a merged page (or, merged image) within the category range by distinguishing between categories.

According to one and more embodiments, as indicated by indicia 1610 and 1620, the electronic device 101 may supplement the movement range by category. For example, when a flick (or rapid swipe) touch gesture is received in the right direction on a page of the third category 530, the watch face of the first category 510 may be moved at most, and the second category 520 beyond the first category 510 may be not moved. For example, when a flick (or rapid swipe) touch gesture is received in the left direction on a page of the second category 520, the watch face of the first category 510 may be moved at most, and the third category 530 beyond the first category 510 may be not moved. For example, the electronic device 101 may automatically control the scroll speed between categories (e.g., stop) regardless of the scroll speed, thereby allowing the user to distinguish between categories and/or recognize the corresponding page.

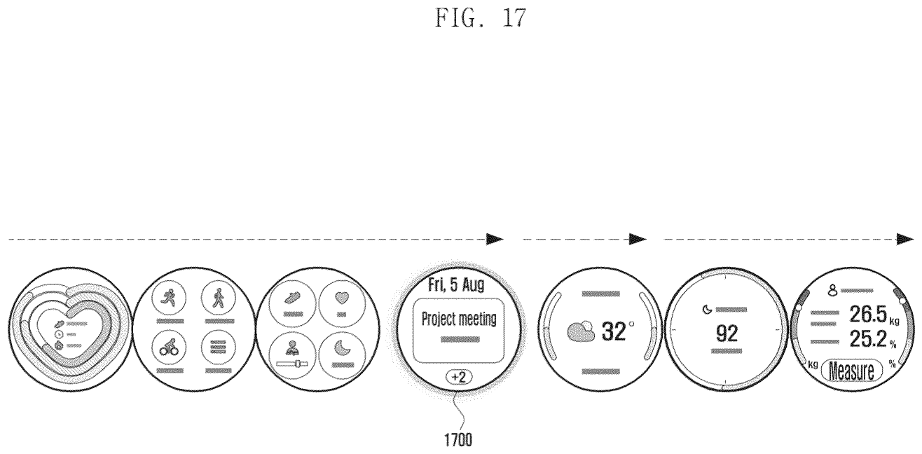

FIG. 17 is a diagram illustrating an example of presenting content in an emphasized manner in the electronic device according to one and more embodiments of the disclosure.

According to one and more embodiments, FIG. 17 may illustrate an example of displaying content in a highlighted manner based on a factor that affects the importance of the content (or, criterion for determining key factors). According to one and more embodiments, in FIG. 17, the key factor may be a notification (e.g., upcoming schedule). For example, if there is a notification to be provided to the user in content within a merged page, the electronic device 101 may automatically control the scroll speed (e.g., slow down) on the page 1700 of the corresponding content to improve user awareness of the corresponding page 1700.

With reference to FIG. 17, while scrolling the merged page at a first speed (e.g., fast scroll), the electronic device 101 may reduce the scroll speed to a second speed lower than the first speed on the page 1700 that includes content determined based on the key factor determination criterion (e.g., upcoming schedule), and display the content in a highlighted manner through a specified effect (e.g., edge highlighting) based on the corresponding page 1700. According to one and more embodiments, after passing the corresponding page 1700, the electronic device 101 may increase the scroll speed to the first speed in the next page portion and continue scrolling. According to one and more embodiments, when receiving a scroll stop input on the page 1700 while scrolling, the electronic device 101 may stop scrolling on the corresponding page 1700 and display the content (e.g., schedule content) of the page 1700 at the stopped position.

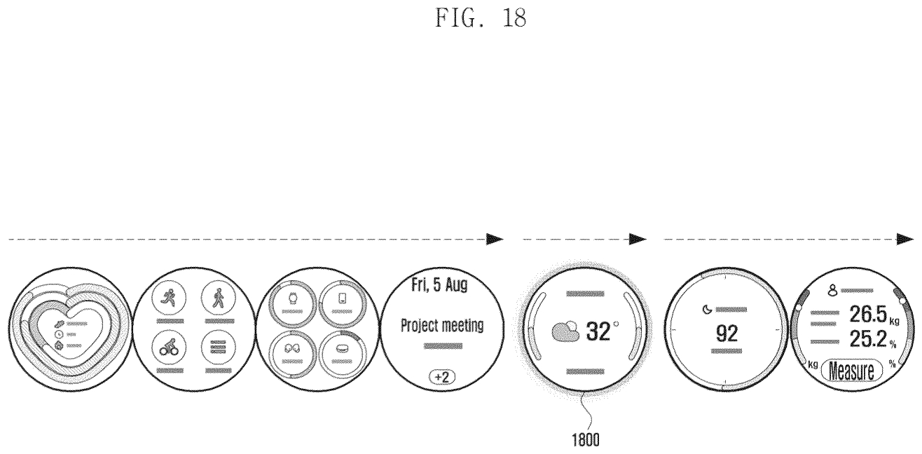

FIG. 18 is a diagram illustrating an example of presenting content in an emphasized manner in the electronic device according to one and more embodiments of the disclosure.

According to one and more embodiments, FIG. 18 may illustrate an example of displaying content in a highlighted manner based on a factor that affects the importance of the content (or, criterion for determining key factors). According to one and more embodiments, in FIG. 18, the key factor may be whether there is a content update or a content information update (e.g., weather information update). For example, if there is updated information in content within the merged page, the electronic device 101 may automatically control the scroll speed (e.g., slow down) on the page 1800 of the corresponding content to improve user awareness of the corresponding page 1800.

With reference to FIG. 18, while scrolling the merged page at a first speed (e.g., fast scroll), the electronic device 101 may reduce the scroll speed to a second speed lower than the first speed on the page 1800 that includes content determined based on the key factor determination criterion (e.g., content update), and display the content in a highlighted manner through a specified effect (e.g., edge highlighting) based on the corresponding page 1800. According to one and more embodiments, after passing the corresponding page 1800, the electronic device 101 may increase the scroll speed to the first speed in the next page portion and continue scrolling. According to one and more embodiments, when receiving a scroll stop input on the page 1800 while scrolling, the electronic device 101 may stop scrolling on the corresponding page 1800 and display the content (e.g., weather content) of the page 1800 at the stopped position.

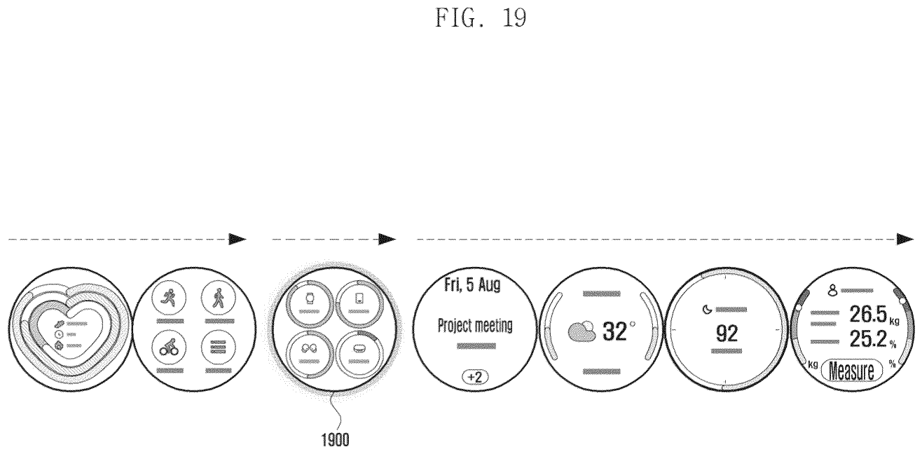

FIG. 19 is a diagram illustrating an example of presenting content in an emphasized manner in the electronic device according to one and more embodiments of the disclosure.

According to one and more embodiments, FIG. 19 may illustrate an example of displaying content in a highlighted manner based on a factor that affects the importance of the content (or, criterion for determining key factors). According to one and more embodiments, in FIG. 19, the key factor may be the amount of content (or, the amount of information). For example, the electronic device 101 may adjust the scroll speed according to the amount of content (or, the amount of information) in the merged page. For example, the electronic device 101 may automatically control the scroll speed (e.g., slow down) on a page 1900 of content with a large amount of information to improve user awareness of the corresponding page 1900.

With reference to FIG. 19, while scrolling the merged page at a first speed (e.g., fast scroll), the electronic device 101 may reduce the scroll speed to a second speed lower than the first speed on the page 1900 that includes content determined based on the key factor determination criterion (e.g., content amount), and display the content in a highlighted manner through a specified effect (e.g., edge highlighting) based on the corresponding page 1900. According to one and more embodiments, after passing the corresponding page 1900, the electronic device 101 may increase the scroll speed to the first speed in the next page portion and continue scrolling. According to one and more embodiments, when receiving a scroll stop input on the page 1900 while scrolling, the electronic device 101 may stop scrolling on the corresponding page 1900 and display the content (e.g., health content) of the page 1900 at the stopped position.

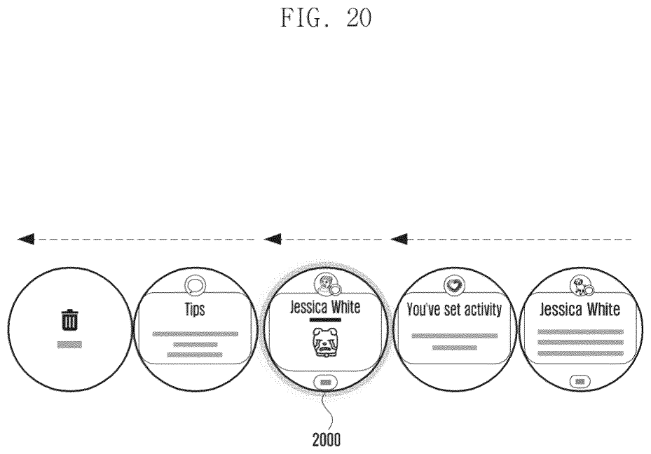

FIG. 20 is a diagram illustrating an example of presenting content in an emphasized manner in the electronic device according to one and more embodiments of the disclosure.

According to one and more embodiments, FIG. 20 may illustrate an example of displaying content in a highlighted manner based on a factor that affects the importance of the content (or, criterion for determining key factors). According to one and more embodiments, in FIG. 20, the key factor may be a notification triggered (or received) by a specified application (or, widget) (e.g., important or user-preferred application) (e.g., contacts application). For example, if there is content related to a notification generated (or received) by a specified application among content of the merged page, the electronic device 101 may automatically control the scroll speed (e.g., slow down) on the page 2000 of the corresponding content to improve user awareness of the corresponding page 2000.

With reference to FIG. 20, while scrolling the merged page at a first speed (e.g., fast scroll), the electronic device 101 may reduce the scroll speed to a second speed lower than the first speed on the page 2000 that includes content determined based on the key factor determination criterion (e.g., notification generated by a specified application), and display the content in a highlighted manner through a specified effect (e.g., edge highlighting) based on the corresponding page 2000. According to one and more embodiments, after passing the corresponding page 2000, the electronic device 101 may increase the scroll speed to the first speed in the next page portion and continue scrolling. According to one and more embodiments, when receiving a scroll stop input on the page 2000 while scrolling, the electronic device 101 may stop scrolling on the corresponding page 2000 and display the content (e.g., notification content) of the page 2000 at the stopped position.

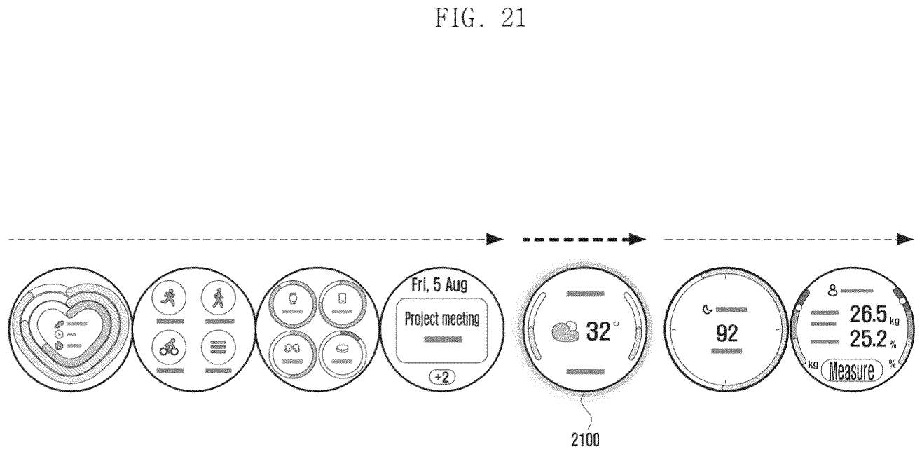

FIG. 21 is a diagram illustrating an example of presenting content in an emphasized manner in the electronic device according to one and more embodiments of the disclosure.

According to one and more embodiments, FIG. 21 may illustrate an example of displaying content in a highlighted manner based on a factor that affects the importance of the content (or, criterion for determining key factors). According to one and more embodiments, in FIG. 21, the key factor may be the frequency of checking information (or, user's preference). For example, the electronic device 101 may control the scroll speed (e.g., slow down or speed up) by reflecting the frequency of checking information (or, user's preference). According to one and more embodiments, if there is information (or content) that is frequently checked by the user among content of the merged page, the electronic device 101 may automatically control the scroll speed (e.g., slow down) on the page 2100 of the corresponding content to improve user awareness of the corresponding page 2100.

With reference to FIG. 21, while scrolling the merged page at a first speed (e.g., fast scroll), the electronic device 101 may reduce the scroll speed to a second speed lower than the first speed on the page 2100 that includes content determined based on the key factor determination criterion (e.g., frequently checked information (or content)), and display the content in a highlighted manner through a specified effect (e.g., edge highlighting) based on the corresponding page 2100. According to one and more embodiments, after passing the corresponding page 2100, the electronic device 101 may increase the scroll speed to the first speed in the next page portion and continue scrolling. According to one and more embodiments, when receiving a scroll stop input on the page 2100 while scrolling, the electronic device 101 may stop scrolling on the corresponding page 2100 and display the content (e.g., weather content) of the page 2100 at the stopped position.

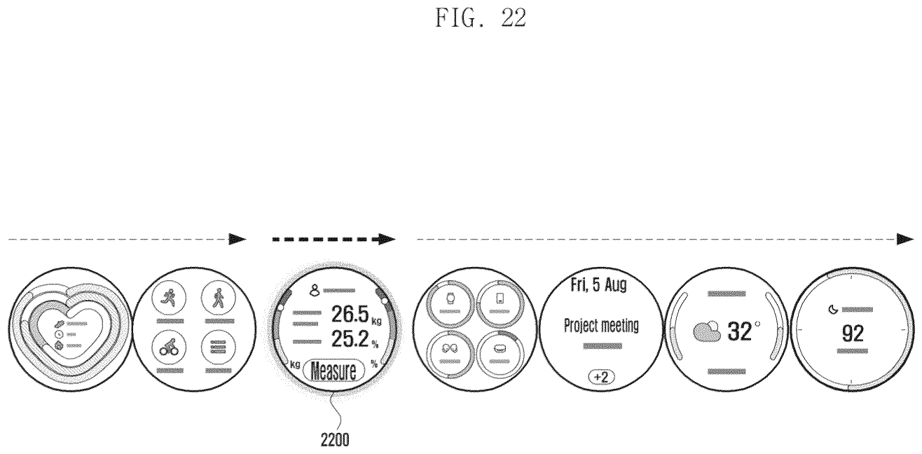

FIG. 22 is a diagram illustrating an example of presenting content in an emphasized manner in the electronic device according to one and more embodiments of the disclosure.

According to one and more embodiments, FIG. 22 may illustrate an example of displaying content in a highlighted manner based on a factor that affects the importance of the content (or, criterion for determining key factors). According to one and more embodiments, in FIG. 22, the key factor may be the frequency of checking information (or, user's preference). For example, the electronic device 101 may control the scroll speed (e.g., slow down or speed up) by reflecting the frequency of checking information (or, user's preference). According to one and more embodiments, if there is information (or content) that is not frequently checked by the user among the content of the merged page, the electronic device 101 may automatically control (e.g., increase) the scroll speed on the page 2200 of the corresponding content (e.g., apply speed weighting to the infrequently viewed page) to allow the corresponding page 2200 to pass by quickly.

With reference to FIG. 22, while scrolling the merged page at a first speed (e.g., fast scroll), the electronic device 101 may increase the scroll speed to a third speed higher than the first speed on the page 2100 that includes content determined based on the key factor determination criterion (e.g., infrequently checked information (or content)), and quickly pass by the corresponding page 2200. According to one and more embodiments, after passing the corresponding page 2200, the electronic device 101 may decrease the scroll speed to the first speed in the next page portion and continue scrolling.

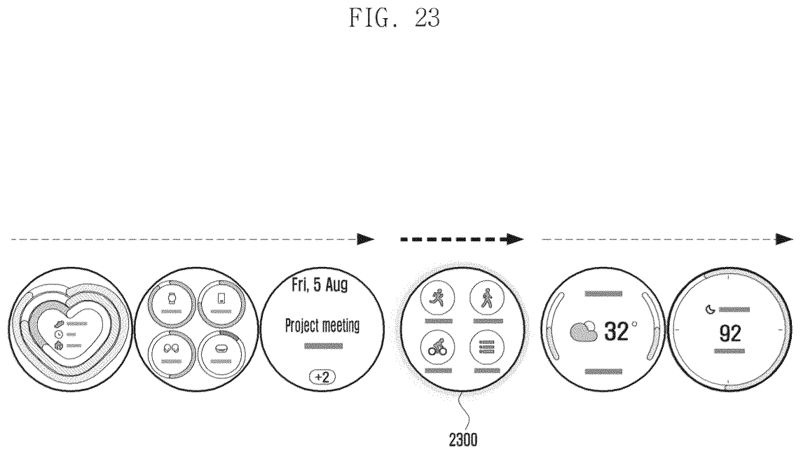

FIG. 23 is a diagram illustrating an example of presenting content in an emphasized manner in the electronic device according to one and more embodiments of the disclosure.

According to one and more embodiments, FIG. 23 may illustrate an example of displaying content in a highlighted manner based on a factor that affects the importance of the content (or, criterion for determining key factors). According to one and more embodiments, in FIG. 23, the key factor may be context (e.g., time and/or place-related) information based on the user's usage pattern. For example, the electronic device 101 may control the scroll speed (e.g., slow down) on a page of related content by reflecting the user's context. According to one and more embodiments, the electronic device 101 may recognize the user's context based on situational awareness and, if there is content related to the recognized context among content of the merged page, may automatically control the scroll speed (e.g., slow down) on the page 2300 of the corresponding content to improve user awareness of the corresponding page 2300. For example, when the user uses the electronic device 101 at a place frequently visited by the user and/or at a time slot of visiting the place, the electronic device 101 may automatically control the scroll speed on the page 2300 of the corresponding content in the merged page.

With reference to FIG. 23, while scrolling the merged page at a first speed (e.g., fast scroll), the electronic device 101 may reduce the scroll speed to a second speed lower than the first speed on the page 2300 that includes content determined based on the key factor determination criterion (e.g., content relevant to the user's context), and display the content in a highlighted manner through a specified effect (e.g., edge highlighting) based on the corresponding page 2300. According to one and more embodiments, after passing the corresponding page 2300, the electronic device 101 may increase the scroll speed to the first speed in the next page portion and continue scrolling. According to one and more embodiments, when receiving a scroll stop input on the page 2300 while scrolling, the electronic device 101 may stop scrolling on the corresponding page 2300 and display the content (e.g., health content) of the page 2300 at the stopped position.

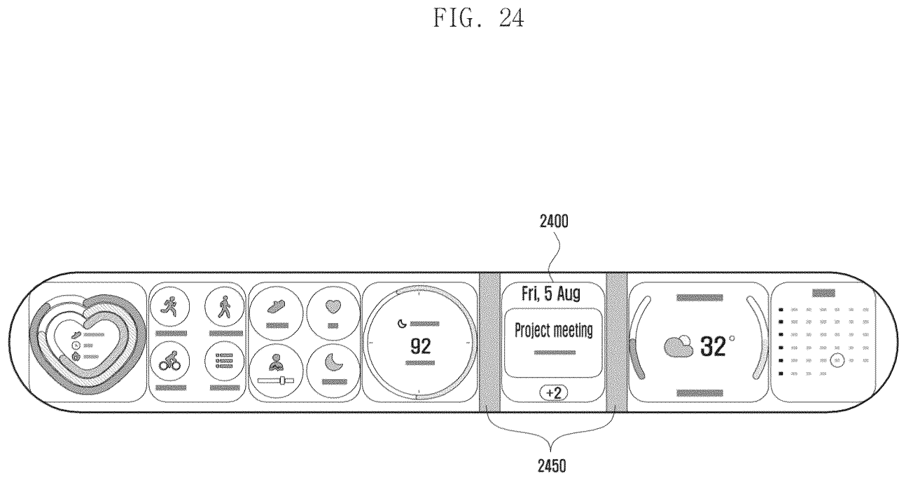

FIG. 24 is a diagram illustrating an example of presenting content in an emphasized manner in the electronic device according to one and more embodiments of the disclosure.

According to one and more embodiments, FIG. 24 may illustrate an example of displaying content in a highlighted manner based on a factor that affects the importance of the content (or, criterion for determining key factors). According to one and more embodiments, FIG. 24 may show an example of controlling the scroll speed (e.g., further slowing down) by adjusting margins 2450 (or width) between pages.

With reference to FIG. 24, while scrolling the merged page at a first speed (e.g., fast scroll), the electronic device 101 may reduce the scroll speed to a second speed lower than the first speed on the page 2400 that includes content determined based on the key factor, and display the content in a highlighted manner through a specified effect (e.g., edge highlighting) based on the corresponding page 2400. According to one and more embodiments, while scrolling the merged page, in a portion of the emphasized page (e.g., focus page) to which the margins 2450 are applied, the electronic device 101 may provide an effect in which the scroll speed is reduced due to the margins 2450 on both sides of the merged page region. According to one and more embodiments, after passing the corresponding page 2400, the electronic device 101 may increase the scroll speed to the first speed in the next page portion and continue scrolling. According to one and more embodiments, when receiving a scroll stop input on the page 2400 while scrolling, the electronic device 101 may stop scrolling on the corresponding page 2400 and display the content of the page 2400 at the stopped position.

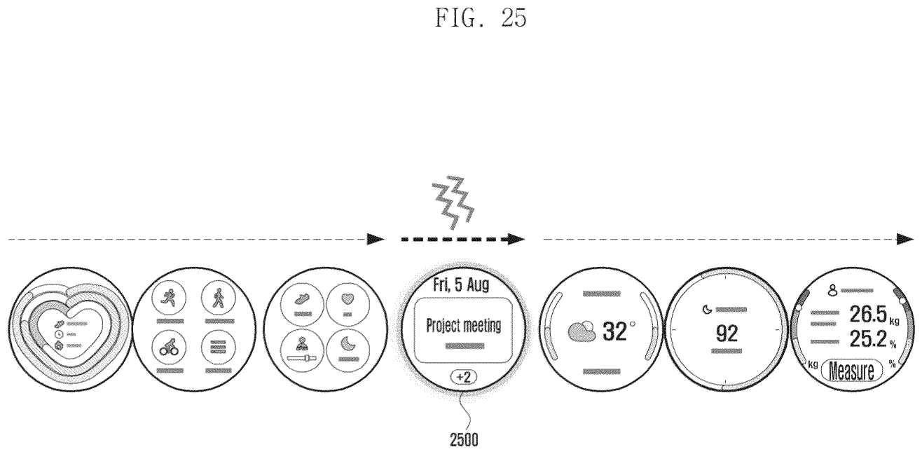

FIG. 25 is a diagram illustrating an example of presenting content in an emphasized manner in the electronic device according to one and more embodiments of the disclosure.

According to one and more embodiments, FIG. 25 may illustrate an example of displaying content in a highlighted manner based on a factor that affects the importance of the content (or, criterion for determining key factors). According to one and more embodiments, FIG. 25 may illustrate an example of providing a designated haptic (e.g., heavy feeling haptic based on speed reduction) together with speed control in a portion of the highlighted page (e.g., focus page). For example, while scrolling the merged page, the electronic device 101 may automatically control the scroll speed (e.g., slow down) on a page 2500 of content to be highlighted and output a designated haptic to enhance user awareness of the corresponding page 2500.

With reference to FIG. 25, while scrolling the merged page at a first speed (e.g., fast scroll), the electronic device 101 may reduce the scroll speed to a second speed lower than the first speed on the page 2500 that includes content determined based on the key factor, and present the content in a highlighted manner through a specified effect (e.g., edge highlighting and haptic) based on the corresponding page 2500. According to one and more embodiments, after passing the corresponding page 2500, the electronic device 101 may increase the scroll speed to the first speed and remove the specified effect in the next page portion to continue scrolling. According to one and more embodiments, when receiving a scroll stop input on the page 2500 while scrolling, the electronic device 101 may stop scrolling on the corresponding page 2500 and display the content of the page 2500 at the stopped position.

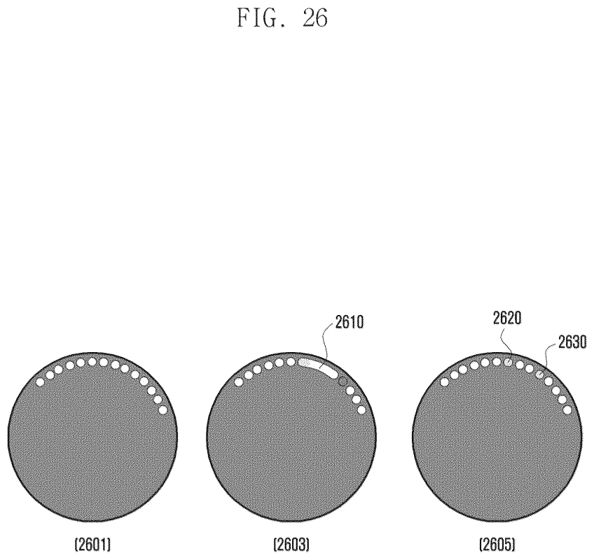

FIG. 26 is a diagram illustrating an example of providing indicators corresponding to page merging in the electronic device according to one and more embodiments of the disclosure.

According to one and more embodiments, FIG. 26 may illustrate an example of providing location information about source pages (or, pages to be merged) of a page merge section based on indicators when merging multiple pages based on the input speed of a user input (e.g., scroll speed).

According to one and more embodiments, indicia 2601 may represent an example of providing default indicators before page merging. For example, indicators may be matched one-to-one with pages. According to one and more embodiments, the electronic device 101 may activate (e.g., highlight) an indicator corresponding to a page currently displayed on the display among the plural indicators to present the indicator.

According to one and more embodiments, indicia 2603 may represent an example of presenting a merged indicator (or, scroll bar) 2610 for those indicators corresponding to the merged page based on page merging. For example, the electronic device 101 may merge indicators corresponding respectively to the source pages of the page merge section when merging pages, and present a merged indicator (or, scroll bar) 2610 at a corresponding position in the indicator region. According to one and more embodiments, while scrolling the merged page, the electronic device 101 may provide the user with scroll progress status through the merged indicator (or, scroll bar) 2610 in correspondence to page scrolling.

According to one and more embodiments, indicia 2605 may illustrate an example of presenting, among the indicators, a start indicator 2620 corresponding to the start page of the merged page and an end indicator 2630 corresponding to the end page of the merged page in an emphasized manner (e.g., highlighting) based on page merging. For example, when merging pages, the electronic device 101 may determine the indicators corresponding to the start page and the end page of the source pages belonging to the page merge section as the start indicator 2620 and the end indicator 2630, respectively. According to one and more embodiments, the electronic device 101 may present the start indicator 2620 and the end indicator 2630, and while scrolling the merged page, may sequentially shift (or, scroll) the highlight from the start indicator 2620 to the end indicator 2630 in response to the scrolling of the page, thereby providing the user with a scroll progress status.

The operation method performed by the electronic device 101 according to one and more embodiments of the disclosure may include an operation of displaying first content on the display. According to one and more embodiments, the operation method may include an operation of receiving a user input for transitioning pages while displaying the first content. According to one and more embodiments, the operation method may include an operation of determining the input speed of the user input based on the user input. According to one and more embodiments, the operation method may include an operation of determining a movement distance based on the input speed. According to one and more embodiments, the operation method may include an operation of setting source pages (or, page merge section) based on the movement distance. According to one and more embodiments, the operation method may include an operation of identifying whether at least one second content having a defined condition is included in the content of the source pages. According to one and more embodiments, the operation method may include an operation of generating, if at least one second content is present, a merged image so that the at least one second content is emphasized. According to one and more embodiments, the operation method may include an operation of displaying the merged page by scrolling based on the direction of the user input.

According to one and more embodiments, the user input may include a first input having a specified speed associated with transitioning over multiple pages, and a second input associated with transitioning on a page basis.

According to one and more embodiments, the operation method may include an operation of performing scrolling the merged page in a specified direction based on the first input. According to one and more embodiments, the operation method may include an operation of performing paging of another page in a specified direction based on the second input.

According to one and more embodiments, the operation of displaying the merged image by scrolling may include an operation of displaying the at least one second content in a highlighted manner based on a specified effect while scrolling the merged page.

According to one and more embodiments, the specified effect may include an effect of slowing down the movement speed of a page portion corresponding to each of the at least one second content, slowing down the movement speed based on margins on both sides of the page portion, edge highlighting, and/or haptic output.

According to one and more embodiments, the operation method may include an operation of identifying the defined condition, an operation of determining whether at least one second content having the defined condition is present based on the content of the source pages, and an operation of marking, if at least one second content is present, at least one page corresponding to the at least one second content among the source pages.

According to one and more embodiments, the defined condition may include a criterion for determining key factors affecting the importance of content.

According to one and more embodiments, the operation method may include an operation of evaluating the defined condition based on user's context, presence of an update, information amount of content, notification trigger, and/or user's preference.

According to one and more embodiments, the marking may include location information for identifying a page on which the at least one second content is located.

According to one and more embodiments, the operation method may include an operation of setting a specified margin to the at least one marked page when merging the source pages.

According to one and more embodiments, the operation method may include an operation of identifying the marked page while scrolling the merged page, and an operation of adjusting the scroll speed based on the marked page.

According to one and more embodiments, the operation of generating the merged image may include an operation of generating the merged image by including a start page and an end page of the source pages, or an operation of generating the merged image based on in-between pages between the start page and the end page of the source pages.

According to one and more embodiments, the operation method may include an operation of merging in advance entire pages set in the electronic device based on a defined condition.

In a non-transitory computer-readable medium storing instructions that, when executed by the processor 120 of the electronic device 101 according to one and more embodiments of the disclosure, cause the processor 120 to perform operations, wherein the instructions, when executed by the processor, may cause the electronic device to: display first content on the display; receive a user input for transitioning pages while displaying the first content; determine the input speed of the user input based on the user input; determine a movement distance based on the input speed; set source pages (or, page merge section) based on the movement distance; identify whether at least one second content having a defined condition is included in the content of the source pages; generate, if at least one second content is present, a merged image so that the at least one second content is emphasized; and display the merged page by scrolling based on the direction of the user input.

It will be understood that all of the embodiments and their technical features described above may be combined with each other in each and every combination, as long as there is no conflict between two embodiments or features. For example, any and all combinations of two or more of the embodiments described above may be contemplated and included within the disclosure. One or more features of any embodiment may be incorporated into any other embodiment and may provide corresponding benefits or advantages.

The electronic device according to one and more embodiments disclosed in this document may be one of devices of various forms. The electronic device may include, for example, a portable communication device (e.g., smartphone), a computer device, a portable multimedia device, a portable medical instrument, a camera, a wearable device, or a home appliance. The electronic device according to one and more embodiments of this document is not limited to those devices described above.

One and more embodiments of this document and terms used therein are not intended to limit the technical features described in this document to specific embodiments, and should be understood as including various modifications, equivalents, or substitutes of a corresponding embodiment. With regard to the description of the drawings, similar reference numerals may be used to refer to similar or related elements. A singular form of a noun corresponding to a specific item may include one or multiple instances of the item unless the relevant context clearly indicates otherwise. In this document, each of phrases such as “A or B”, “at least one of A and B”, “at least one of A or B”, “A, B or C”, “at least one of A, B and C”, and “at least one of A, B or C” may include any one of or all possible combinations of the items enumerated together in the corresponding one of the phrases. Terms such as “1st” and “2nd”, or “first” and “second” may be used to simply distinguish a corresponding component from another, and does not limit the components in other aspect (e.g., importance or order). When an element (e.g., first element) is referred to, with or without the term “operably” or “communicatively”, as “coupled to/with” or “connected to/with” another element (e.g., second element), this means that the element may be connected or coupled to the other element directly (e.g., wiredly), wirelessly, or via a third element.

The term “module” used in one and more embodiments of this document may include a unit implemented in hardware, software, or firmware, and may be used interchangeably with other terms, for example, “logic”, “logic block”, “component”, or “circuit”. A module may be a single integral component, or a minimum unit or part thereof performing one or more functions. For example, according to one and more embodiments, a module may be implemented in a form of an application-specific integrated circuit (ASIC).

One and more embodiments of this document may be implemented as software (e.g., programs 140) including one or more instructions that are stored in a storage medium (or, recording medium) (e.g., internal memory 136 or external memory 138) readable by a machine (e.g., electronic device 101). For example, a processor (e.g., processor 120) of the machine (e.g., electronic device 101) may invoke at least one of the one or more instructions stored in the storage medium to execute it. This allows the machine to be operated to perform at least one function according to the invoked at least one instruction. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., electromagnetic wave), but this term does not distinguish whether data is stored semi-permanently or temporarily in the storage medium.

According to one and more embodiments, a method according to one and more embodiments disclosed in this document may be provided by being included in a computer program product. The computer program product may be traded as a commodity between a seller and a purchaser. A computer program product may be distributed in the form of a machine-readable storage medium (e.g., compact disc read only memory (CD-ROM)) or be distributed online (e.g., download or upload) directly between two user devices (e.g., smartphones) through an application store (e.g., PlayStore™). For on-line distribution, at least a portion of the computer program product may be temporarily stored or temporarily created in a machine readable storage medium (or, recording medium) such as a memory of a manufacturer's server, an application store's server, or a relay server.

According to one and more embodiments, each component (e.g., module or program) of the above-described components may include a single entity or multiple entities, and some of the multiple entities may be separately arranged on other components. According to one and more embodiments, one or more components or operations may be omitted from the above-described components, or one or more other components or operations may be added. Alternatively or additionally, a plurality of components (e.g., modules or programs) may be integrated into a single component. In this case, the integrated component may perform one or more functions of each of the plurality of components in the same or similar manner as they are performed by a corresponding one of the plurality of components before the integration. According to one and more embodiments, operations performed by a module, a program, or another component may be carried out in sequence, in parallel, by repetition, or heuristically, or one or more of the operations may be executed in a different order or may be omitted, and one or more other operations may be added.

The one and more embodiments of the disclosure disclosed in this specification and drawings are specific examples presented to explain the technical contents of the disclosure and to help understand the disclosure, and are not intended to limit the scope of the disclosure. Therefore, the scope of the disclosure should be interpreted to include all changes or modifications derived based on the technical idea of the disclosure in addition to those embodiments disclosed herein.

What is claimed is:

1. An electronic device comprising:
a display;
at least one processor including processing circuitry; and
memory storing instructions,
wherein the instructions, when executed individually or collectively by the at least one processor, cause the electronic device to:
display first content on the display;
receive a user input for transitioning pages while displaying the first content;
determine an input speed of the user input;
determine a movement distance based on the input speed;
identify source pages based on the movement distance;
identify whether at least one second content having a defined condition is included in at least one of the source pages;
based on the at least one second content being included in at least one of the source pages, generate a merged page based on the source pages, wherein the merged page comprises an emphasis on the at least one second content; and
display the merged page by scrolling based on a direction of the user input.

2. The electronic device of claim 1, wherein the user input comprises a first input having a specified speed related to transitioning over multiple pages, and a second input related to transitioning on a page basis; and
wherein the instructions, when executed individually or collectively by the at least one processor, further cause the electronic device to:
perform scrolling of the merged page in a specified direction based on the first input, and
perform paging of another page, not included in the merged page, in a specified direction based on the second input.

3. The electronic device of claim 1, wherein the instructions, when executed individually or collectively by the at least one processor, further cause the electronic device to display the at least one second content in a highlighted manner based on a specified effect while scrolling the merged page; and
wherein the specified effect comprises at least one of slowing down a movement speed of a portion of the merged page corresponding to the at least one second content, slowing down the movement speed based on margins on both sides of the portion of the merged page, displaying edge highlighting, or haptic output.

4. The electronic device of claim 1, wherein the instructions, when executed individually or collectively by the at least one processor, further cause the electronic device to:
evaluate the defined condition,
determine whether the at least one second content having the defined condition is included in at least one of the source pages based on content of the source pages, and
based on the at least one second content being included in at least one of the source pages, mark at least one page corresponding to the at least one second content among the source pages.

5. The electronic device of claim 4, wherein the defined condition comprises a criterion for determining a factor related to importance of content; and
wherein the instructions, when executed individually or collectively by the at least one processor, further cause the electronic device to evaluate the defined condition based on a user's context, a presence or absence of an update, an amount of information in content, a notification trigger, or a user's preference.

6. The electronic device of claim 4, wherein the instructions, when executed individually or collectively by the at least one processor, further cause the electronic device to set a specified margin in the marked at least one page when generating the merged page; and
wherein the marking comprises location information for identifying a page among the source pages on which the at least one second content is located.

7. The electronic device of claim 4, wherein the instructions, when executed individually or collectively by the at least one processor, further cause the electronic device to:
identify a marked page while scrolling the merged page, and
adjust a scroll speed based on the marked page.

8. The electronic device of claim 1, wherein the instructions, when executed individually or collectively by the at least one processor, further cause the electronic device to:
based on the merged page comprising a start page of the source pages and an end page of the source pages, display, on the display, the start page,
display a start page portion of the merged page with a specified transition effect in response to the user input,
scroll from the start page portion to an end page portion of the merged page, and
display the end page with a specified transition effect upon reaching the end page portion.

9. The electronic device of claim 1, wherein the instructions, when executed individually or collectively by the at least one processor, further cause the electronic device to generate the merged page based on pages between a start page and an end page of the source pages.

10. The electronic device of claim 1, wherein the instructions, when executed individually or collectively by the at least one processor, further cause the electronic device to merge the source pages prior to receipt of the user input based on the defined condition.

11. The electronic device of claim 10, wherein the instructions, when executed individually or collectively by the at least one processor, further cause the electronic device to:
monitor the defined condition for content,
merge the source pages to generate an image based on detecting the defined condition, and
update the merged page using the generated image, and
wherein the defined condition comprises at least one of an update related to content causing a change in data of the content, or a the display being turned on or turned off.

12. A method of operating an electronic device, the method comprising:
displaying first content on a display of the electronic device;
receiving a user input for transitioning pages while displaying the first content;
determining an input speed of the user input;
determining a movement distance based on the input speed;
identifying source pages based on the movement distance;
identifying whether at least one second content having a defined condition is included in at least one of the source pages;
based on the at least one second content being included in at least one of the source pages, generating a merged page based on the source pages, wherein the merged page comprises an emphasis on the at least one second content; and
displaying the merged page by scrolling based on a direction of the user input.

13. The method of claim 12, wherein the user input comprises a first input having a specified speed related to transitioning over multiple pages, and a second input related to transitioning on a page basis, and
wherein the method further comprises:
performing scrolling of the merged page in a specified direction based on the first input; and
performing paging of another page, not included in the source pages, in a specified direction based on the second input.

14. The method of claim 12, wherein the displaying the merged page by scrolling comprises displaying the at least one second content in a highlighted manner based on a specified effect while scrolling the merged page, and
wherein the specified effect comprises at least one of slowing down a movement speed of a portion of the merged page corresponding to the at least one second content, slowing down the movement speed based on margins on both sides of the portion of the merged page, displaying edge highlighting, or haptic output.

15. The method of claim 12, further comprising:
evaluating the defined condition;
determining whether the at least one second content having the defined condition is included in at least one of the source pages based on content of the source pages; and
based on the at least one second content being included in at least one of the source pages, marking at least one page corresponding to the at least one second content among the source pages.

16. The method of claim 15, wherein the defined condition comprises a criterion for determining a factor related to importance of content, and
wherein the method further comprises evaluating the defined condition based on a user's context, a presence or absence of an update, an amount of information in content, a notification trigger, or a user's preference.

17. The method of claim 15, wherein the marking comprises location information for identifying a page among the source pages on which the at least one second content is located, and
wherein the method further comprises setting a specified margin in the marked at least one marked when generating the merged page.

18. The method of claim 16, further comprising:
identifying a marked page while scrolling the merged page; and
adjusting a scroll speed based on the marked page.

19. The method of claim 13, wherein the generating the merged page comprises generating the merged page by including a start page and an end page of the source pages, or generating the merged page based on pages between the start page and the end page of the source pages, and
wherein the method further comprises merging the source pages prior to receipt of the user input based on the defined condition.

20. A non-transitory computer-readable medium having instructions stored therein, which when executed by at least one processor of an electronic device, cause the at least one processor to execute a method of operating the electronic device, the method comprising:
displaying first content on a display of the electronic device;
receiving a user input for transitioning pages while displaying the first content;
determining an input speed of the user input;
determining a movement distance based on the input speed;
identifying source pages based on the movement distance;
identifying whether at least one second content having a defined condition is included in at least one of the source pages;
based on the at least one second content being included in at least one of the source pages. generating a merged page based on the source pages. wherein the merged page comprises an emphasis on the at least one second content; and
displaying the merged page by scrolling based on a direction of the user input.
